(19) United States
(12) Patent Application Publication
(10) Pub. No.: US 2025/0312730 A1
(43) Pub. Date: Oct. 9, 2025

(54) ACIDIC GAS ABSORBENTS COMPRISING IONIC LIQUIDS

(71) Applicant: Commonwealth Scientific and Industrial Research Organisation, Acton (AU)

(72) Inventors: Colin WOOD, Western Australia (AU); Cameron WHITE, Western Australia (AU); Matthew MYERS, Western Australia (AU)

(21) Appl. No.: 18/860,353

(22) PCT Filed: Apr. 28, 2023
(86) PCT No.: PCT/AU2023/050348

§ 371 Date: Oct. 25, 2024

(30) Foreign Application Priority Data
Apr. 28, 2022 (AU) 2022901111

(51) Int. Cl. B01D 53/14; B01D 53/50; B01D 53/52; B01D 53/62; B01D 53/80; B01D 53/96; B01J 20/26; B01J 20/32

(52) U.S. Cl. CPC B01D 53/1493; B01D 53/1425; B01D 53/1468; B01D 53/1475; B01D 53/1481; B01D 53/507; B01D 53/52; B01D 53/62; B01D 53/80; B01D 53/96; B01J 20/267; B01J 20/321; B01D 2252/204; B01D 2252/30; B01D 2257/302; B01D 2257/304; B01D 2257/504; B01D 2258/0283

(57) ABSTRACT

The present disclosure is directed to an acidic gas absorbent particulate for capture of an acidic gas from a gaseous stream or atmosphere, the acidic gas absorbent particulate comprising swellable support particles, wherein the swellable support particles contain absorbed amine-functionalised ionic liquid for absorbing the acidic gas, and to apparatuses, processes, methods and uses comprising the same.

### FIELD

The present disclosure relates to acidic gas absorbents. In particular, the present disclosure relates to acidic gas absorbent particulates comprising ionic liquids, particularly amine-functionalised ionic liquids, which can be used for removing one or more acidic gases from a gaseous stream or atmosphere. The present disclosure also relates to processes for preparing the acidic gas absorbent particulates and to methods for removing one or more acidic gases from a gaseous stream or atmosphere using the acidic gas absorbent particulates. The present disclosure also relates to an acidic gas removal apparatus comprising the acidic gas absorbent particulate for capturing one or more acidic gases from a gaseous stream or atmosphere.

### BACKGROUND

Various approaches have been used for acidic gas (e.g. CO₂) capture including the use of liquid and solid-based sorbents. Liquid-based sorbents that are employed typically comprise groups that chemically react with the acidic gas which can capture CO₂ from gaseous streams, including for example aqueous organic amine solutions (which have basic characteristics). Such organic amine based solutions present a number of drawbacks, including low capture efficiency arising from gas-liquid contact area limitations, intensive energy requirements for desorption of CO₂ from the liquid solution, corrosivity to steel pipes, thermal or chemical degradation of the amine groups and/or loss of volatile amines into gaseous streams.

To address uptake rate limitations associated with liquid sorbents, various high surface area solid-based sorbents have been proposed with metal organic frameworks (MOFs) being extensively studied. Whilst MOFs may offer improvements over liquid based sorbents, the cost of synthesis can be high which inhibits large scale production. Additionally, many of these porous support materials demonstrate decreased stability over time and reduced gas absorption performance due to degradation owing to sensitivity to contaminants present in gaseous streams or the atmosphere (e.g. water), poor regeneration during acidic gas absorption/desorption and/or leaching of the liquid out of the support. Liquid sorbents supported on rigid non-swellable porous supports, such as silica address some of these concerns; however, leaching is a major concern upon regeneration. Accordingly, there is a need for alternative or improved materials with improved performance and longevity for use in acidic gas capture which overcome at least one or more of the problems discussed above and/or provides the public with a useful alternative.

It will be understood that any prior art publications referred to herein do not constitute an admission that any of these documents form part of the common general knowledge in the art, in Australia or in any other country.

### SUMMARY

The present disclosure provides particular acidic gas absorbents for removing acidic gases from gaseous streams or atmospheres, that are scalable for industrial application and can be tailored to provide control over acidic gas absorption and/or desorption. In particular, the acidic gas absorbents described herein can remove acidic gases (e.g. CO₂, H₂S or SO₂) from gaseous streams or atmospheres by absorbing the acidic gas thereby removing it from the gaseous stream or atmosphere. The absorbed acidic gas can then be harvested (e.g. desorbed) from the absorbent, which is regenerated and can be reused to absorb more acidic gas from the gaseous stream or atmosphere (e.g. recycled).

It has now been surprisingly discovered that an acidic gas absorbent particulate comprising swellable support particles (particularly hydrogel particles) can absorb and retain amine-functionalised ionic liquids whilst retaining both good acidic gas absorption properties and remain “dry” and flowable, despite the ionic liquids high viscosity that have traditionally limited their uptake kinetics, especially as this viscosity also typically increases with CO₂ uptake limiting the gas diffusion within the ionic liquid. According to some embodiments or examples, the ionic liquid exists as microdroplets within the swellable support, resulting in the acidic gas diffusion distance being significantly reduced allowing for enhanced sorbent uptake kinetics/efficiency, giving rise to improved performance. Owing to their flowable properties, the acidic gas absorbent particulate can be introduced into gas pipelines, such as for use in in-line post combustion CO₂ capture from flue gas.

In one aspect, there is provided an acidic gas absorbent particulate for removing an acidic gas from a gaseous stream or atmosphere, the acidic gas absorbent particulate comprising swellable support particles and an amine-functionalised ionic liquid absorbed within the swellable support particles. In a related aspect, there is provided an acidic gas absorbent particulate for capture of an acidic gas from a gaseous stream or atmosphere, the acidic gas absorbent particulate comprising hydrogel particles, wherein the hydrogel particles contain absorbed amine-functionalised ionic liquid for absorbing the acidic gas.

In another aspect, there is provided a process for preparing an acidic gas absorbent particulate described herein, comprising contacting an amine-functionalised ionic liquid with swellable support particles under conditions effective to absorb the amine-functionalised ionic liquid within the swellable support particles. In a related aspect, there is provided a process for preparing an acidic gas absorbent particulate described herein, comprising contacting an amine-functionalised ionic liquid with hydrogel particles under conditions effective to absorb the amine-functionalised ionic liquid within the hydrogel particles.

In another aspect, there is provided a method for removing an acidic gas from a gaseous stream or atmosphere, comprising contacting the gaseous stream or atmosphere with an acidic gas absorbent particulate described herein for absorbing at least some of the acidic gas from the gaseous stream or atmosphere. In a related aspect, there is provided a method for removing an acidic gas from a gaseous stream or atmosphere, comprising contacting the gaseous stream or atmosphere with the acidic gas absorbent particulate described herein to absorb at least some of the acidic gas from the gaseous stream or atmosphere into the absorbed amine-functionalised ionic liquid contained within the hydrogel particles.

In another aspect, there is provided an acidic gas removal apparatus for capturing an acidic gas from a gaseous stream or atmosphere containing the acidic gas comprising: a chamber enclosing an acidic gas absorbent particulate described herein, the chamber comprising an inlet through which a gaseous stream or atmosphere can flow to the acidic gas absorbent particulate and an outlet through which the effluent gaseous stream or atmosphere can flow out from the acidic gas absorbent particulate. In a related aspect, there is provided an acidic gas removal apparatus for capturing acidic gas comprising a chamber enclosing an acidic gas absorbent particulate described herein, wherein the chamber brings the gaseous stream or atmosphere into contact with the hydrogel particles to absorb at least some of the acidic gas into the absorbed amine-functionalised ionic liquid contained within the hydrogel particles.

It will be appreciated that any one or more of the embodiments and examples described herein for the acidic gas absorbent may also apply to the processes, methods and/or apparatuses described herein. Any embodiment herein shall be taken to apply mutatis mutandis to any other embodiment unless specifically stated. It will also be appreciated that other aspects, embodiments and examples of the acidic gas absorbent particulate, processes, methods and/or apparatuses reactors are described herein.

It will also be appreciated that some features of acidic gas absorbent particulate, processes, methods and/or apparatuses reactors identified in some aspects, embodiments or examples as described herein may not be required in all aspects, embodiments or examples as described herein, and this specification is to be read in this context. It will also be appreciated that in the various aspects, embodiments or examples, the order of method or process steps may not be essential and may be varied.

### BRIEF DESCRIPTION OF FIGURES

Preferred embodiments of the present disclosure are further described and illustrated as follows, by way of example only, with reference to the accompanying drawings in which:

FIG. 1: Illustration of the fabrication, structure and use in acidic gas capture of an acidic gas absorbent particulate according to one or more embodiments of the present disclosure, where an amine-functionalised ionic liquid is absorbed within swellable support particles: Combining solutions comprising cation (1) (e.g. choline hydroxide) and anion (e.g. sarcosine) to form the amine-functionalised ionic liquid (2). 3) Addition of ionic liquid to swellable support to form acidic gas absorbent; 4) CO₂ capture within acidic gas absorbent.

FIG. 2: Photo of an acidic gas absorbent particulate comprising saw dust particles swollen with tetrabutylammonium sarcosinate.

FIG. 3: Schematic of the experimental set-up for evaluating the CO₂ absorption performance of the acidic gas absorbent particulates. 1) Air compressor. 2) Gas pressure gauge 3) Mass flow controller 4) Water bubbler for humidifying gas stream 5) Sample column 6) Isotopic/gas concentration analyzer.

FIG. 4: CO₂ sorption curves by flowing air through a column of acidic gas absorbent particulate comprising sawdust particles are swollen with tetrabutylammonium sarcosinate (TSA).

FIG. 5: Depicts an apparatus for performing the method for capture of an acidic gas from a gaseous stream or atmosphere, according to some embodiments of the disclosure.

FIG. 6: CO₂ sorption curve by flowing air through a column of acidic gas absorbent particulate comprising polyethylenimine particles are swollen with tetrabutylammonium sarcosinate (TSA).

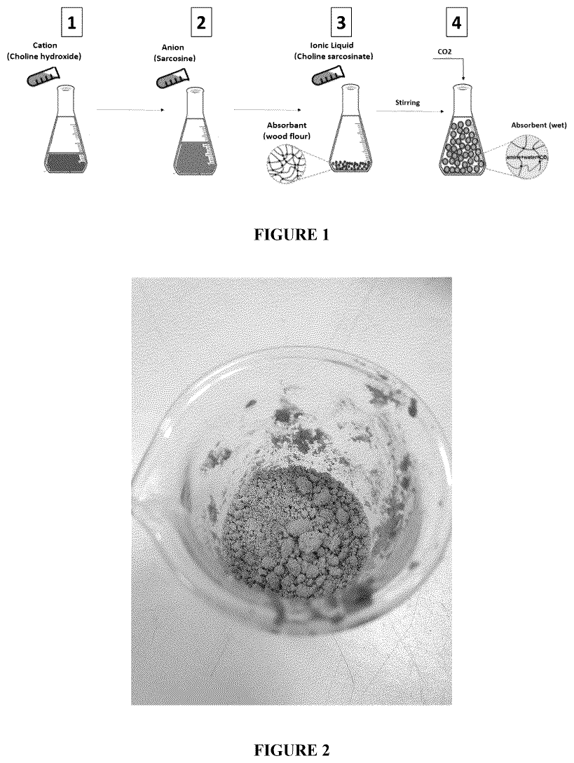

### DETAILED DESCRIPTION

The present disclosure describes the following various non-limiting embodiments, which relate to investigations undertaken to identify acidic gas absorbents for removing acidic gases from gaseous streams or atmospheres. Additional non-limiting embodiments of the acidic gas absorbents and various processes, methods and apparatuses are also described.

The acidic gas absorbent described herein comprises swellable support particles and an amine-functionalised ionic liquid, which is further described below according to various non-limiting embodiments and examples. It has been surprisingly found that the acidic gas absorbent particulate described herein provided one or more advantages over conventional liquid and/or solid-based absorbents including, but not limited to increased acidic gas absorption capacity, improved sorbent recyclability, near zero amine-solvent volatility, more robust in humid environments, and/or reduced environmental impact.

At least according to some embodiments or examples described herein, the amine-functionalised ionic liquid absorbed within the swellable support particles provides a chemical absorption mechanism of the acidic gas (which may operate in addition to a physical absorption mechanism) for the absorption of acidic gases from gaseous streams or atmospheres, whilst the swellable support particles can swell beyond its initial dry state pore volume to provide increased retention of the amine-functionalised ionic liquid absorbed therein and consequently reduced leaching compared to conventional solid-based absorbents. In one example, the amine-functionalised ionic liquids absorbed within the swellable support particles can absorb CO₂ from gaseous streams or atmospheres via the formation of carbamic acid compared to conventional liquid and/or solid organic amine based absorbents utilising liquid amines that solely rely on carbamate formation, thus increasing the CO₂ to amine sorption ratio and overall absorption efficiency. Other applications and advantages associated with the acidic gas absorbent are also described herein.

### General Terms

In the following description, reference is made to the accompanying drawings which form a part hereof, and which is shown, by way of illustration, several embodiments. It is understood that other embodiments may be utilized and structural changes may be made without departing from the scope of the present disclosure.

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Any discussion of documents, acts, materials, devices, articles or the like which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, hydrogels, processes, and compositions, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

As used herein, the term “about”, unless stated to the contrary, typically refers to a range of up to +/−10% of the designated value, and includes smaller ranges therein, for example +/−5% or +/−1% of the designated value.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 4.5, 4.75, and 5, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The reference to “substantially free” generally refers to the absence of that compound or component in the acidic gas absorbent particulate, gaseous stream or atmosphere other than any trace amounts or impurities that may be present, for example this may be an amount by weight % in the total acidic gas absorbent particulate, gaseous stream or atmosphere of less than about 1%, 0.1%, 0.01%, 0.001%, or 0.0001%. The acidic gas absorbent particulate, gaseous streams or atmosphere as described herein may also include, for example, impurities in an amount by weight % in the total acidic gas absorbent particulate, gaseous stream or atmosphere of less than about 5%, 4%, 3%, 2%, 1%, 0.5%, 0.1%, 0.01%, 0.001%, or 0.0001%. For example, this may be an amount by vol. % in the total gaseous stream or atmosphere of less than about 5%, 4%, 3%, 2%, 1%, 0.5%, 0.1%, 0.01%, 0.001%, or 0.0001%. For example, the gaseous streams or atmospheres as described herein may also include, for example, impurities in an amount by vol. % in the total gaseous stream of less than about 5%, 4%, 3%, 2%, 1%, 0.5%, 0.1%, 0.01%, 0.001%, or 0.0001%. An example of such an impurity is the amount of methane (CH₄) that may be present in air, being present in an amount of less than 0.0005 vol. %.

The term “optionally substituted” means that a functional group is either substituted or unsubstituted, at any available position. The term “substituted” as referred to above or herein may include, but is not limited to, groups or moieties such as halogen, hydroxyl, carboxyl, alkyl, or haloalkyl.

The term “optionally linked” means a group may be attached to another group via a linker group (e.g. divalent linking group such as an alkyl, heteroatom, or heteroalkyl) or may be directly attached to another group without a linker group.

### Acidic Gas Absorbents

The present disclosure is directed to providing improvements in acidic gas absorbents including improved acidic gas absorption and performance. It has been surprisingly discovered that the inclusion of an amine-functionalised ionic liquid within the swellable support particles can provide an acidic gas absorbent with increased gas absorption capacity and/or improved stability compared to conventional liquid- and/or solid-based absorbents. In particular, the particulate morphology of the absorbent can increase the contact of the acidic gas in the stream or atmosphere with the amine-functionalised ionic liquid. Other advantages provided by the acidic gas absorbent are also described herein.

The acidic gas absorbent is a particulate. The term “particulate” refers to the form of discrete solid units. The units may take the form of flakes, fibres, agglomerates, granules, powders, spheres, dust, pulverized materials or the like, as well as combinations thereof. The particulate may have any desired shape including, but not limited to, cubic, rod like, polyhedral, spherical or semi-spherical, rounded or semi-rounded, angular, irregular, and so forth. The particulate morphology can be determined by any suitable means such as optical microscopy.

In some embodiments, the mean average particle size (in μm) of the acidic gas absorbent particulate (e.g. the swellable support particulate swollen with the amine-functionalised ionic liquid) may be at least about 1, 5, 10, 20, 50, 100, 200, 300, 400, 500, 700, 1000, 1500, or 2000. In some embodiment, the mean average particle size (in μm) of the acidic gas absorbent particulate may be less than about 2000, 1500, 1000, 700, 500, 400, 300, 200, 100, 50, 20, 10, 5 or 1. The mean average particle size of the acidic gas absorbent may be in a range provided by any two of these upper and/or lower values, for example the mean average particle size (in μm) may be between about 10 to 2000, 10 to 1000, or 10 to 500. In one particular embodiment, the mean average particle size of the acidic gas absorbent particulate (in μm) is between about 10 to about 500, for example between about 10 to about 400. The particle size is taken to be the longest cross-sectional diameter across an acidic gas absorbent particle. For non-spherical acidic gas absorbent particles, the particle size is taken to be the distance corresponding to the longest cross-section dimension across the particle. The mean average particle size can be determined by any standard method, including for example optical microscope, dynamic light scattering and/or electron microscopy techniques. An acidic gas absorbent particulate may provide one or more advantage, including for example an increased surface area for greater contact and subsequent absorption of acidic gas.

In one embodiment, the acidic gas absorbent particulate may be self-supporting. The term ‘self-supporting’ as used herein refers to the ability of the acidic gas absorbent particulate to maintain its morphology in the absence of an external scaffold material, such as a porous zeolite or a metal organic framework (MOF). For example, the acidic gas absorbent particles maintain their morphology in the absence of a scaffold. The self-supported nature of the acidic gas absorbent particulate may provide certain advantages, for example allows particulate of the acidic gas absorbent material to be contacted with the gaseous stream or atmosphere using a fluidized bed reactor. Thus it will be understood that, where the acidic gas absorbent particulate is “self-supporting”, there is no exogenous scaffold required to maintain the structure of the acidic gas absorbent particulate.

In some embodiments, the acidic gas absorbent particulate is flowable (i.e. exhibits dry and powdery properties) allowing it to flow as a “dry”, free-flowing loose particulate without being overly sticky or rigid, despite the high loading of absorbed amine-functionalised ionic liquid, because the absorbed liquid is contained inside the pores of the swollen swellable particles. According to at least some embodiments or examples, it has been surprisingly found that such flowable properties could be achieved whilst swollen with highly viscous amine-functionalised ionic liquids, which typically render other conventional scaffolds or porous non-swellable supports rigid and sticky. In one embodiment, the acidic gas absorbent particulate is in the form of a free-flowing powder.

In some embodiments, the acidic gas absorbent particulate may be provided as layer within a column, wherein the gaseous stream or atmosphere is flowed through the column and passes through the layer comprising the acidic gas absorbent particulate. The layer is not limited to any particular morphology. In one example, a suitable column may be packed with a particulate of acidic gas absorbent to form a packed-bed with sufficient interstitial space between adjacent particles to allow a flow of gas therethrough. Alternatively, the acidic gas absorbent particulate may be provided in flow with the gaseous stream or atmosphere (e.g. a fluidised bed reactor).

In some embodiments, the acidic gas absorbent particulate may be provided as a coating composition on a substrate. In some embodiments, the substrate may be planar, for example a planar sheet. In a particular example, the substrate may be a flexible sheet. A planar substrate provides a two sided element onto which the acidic gas absorbent particulate coating composition can be applied. Each substrate may be coated with the acidic gas absorbent particulate coating composition on two opposing sides. The planar substrate can have any configuration. In some embodiments, the planar substrate may comprise a flat solid surface. In other embodiments, the planar substrate may comprise one or more apertures, designed to assist gas flow through and around the substrate. In a particular embodiment, the substrate may comprise a mesh, for example, micro wire mesh. The use of a mesh provides a multitude of apertures, (e.g. micro size apertures), thereby providing a high surface area on which the acidic gas absorbent particulate coating composition can be applied, whilst also providing a suitable flow path having a reasonably low pressure drop across the substrate (relative to the size and configuration of the mesh) compared to other configurations, for example, packed beds.

### Amine-Functionalised Ionic Liquids

The acidic gas absorbent particulate comprises swellable support particles and an amine-functionalised ionic liquid absorbed within the swellable support particles. The amine-functionalised ionic liquid is for absorbing the acidic gas. In one embodiment, the swellable support particles may be hydrogel particles which contain absorbed amine-functionalised ionic liquid for absorbing the acidic gas.

As used herein, an “ionic liquid” refers to organic salts which are capable of being melted to form a liquid state at ambient temperature or temperatures up to 100° C., as is the case for flue gas where the temperature of the acid gas may be elevated. The resulting ionic liquid is composed of essentially ions (e.g. a mixture of anions and cations), and owing to the ions being poorly coordinated is a liquid below 100° C., and in some cases even at room temperature (referred to as room temperature ionic liquids). As used herein, the term “amine-functionalised” refers to an ionic liquid in which one or more of its components (e.g. cation and/or anion) is functionalised with one or more amine groups, as described herein.

Ionic liquids possess several properties that render them suitable for use as acidic gas absorbents as opposed to more traditional amine based liquids, including: (1) the energy requirements for desorption may also be lower than for amine solutions due a reliance on a physical absorption mechanism. Further efficiency can be attained by their typical low vapour pressure and non-volatility, which renders them generally non-flammable and allows them to be generated and reused with no appreciable losses into the gas stream; (2) ionic liquids are generally not corrosive; (3) ionic liquids generally display thermal and chemical stability, and typically degrade at high temperatures above 250° C. Furthermore, ionic liquids are generally resistant to degradation by oxidative mechanisms, and to reaction with impurities; and (4) can be tuned to alter various properties through manipulation of the anions and/or cations.

However, for conventional ionic liquids, absorption of acidic gas (e.g. CO₂) generally occurs through a physical absorption mechanism which involves the dissolution of the acidic gas into the ionic liquid without the formation of chemical interactions between the dissolved acidic gas and the ionic liquid ions. This physical absorption mechanism leads to conventional ionic liquids demonstrating low CO₂ absorption. One approach to address such low absorption capacity of conventional ionic liquids is to use task-specific ionic liquids bearing functional groups on the cation and/or anion which introduce an additional chemical absorption mechanism.

For example, amine-functionalised ionic liquids can chemically react with CO₂ via a reaction with the amine on the ionic liquid. If the amine functionality is linked to the cation, intermolecular carbamate formation takes place resulting in a maximum capture stoichiometry of one mole CO₂ for every two moles of ionic liquid. If the amine functionality is attached to the anion, the negatively charged conjugate base on the anion can take up the proton released upon CO₂ capture forming carbamic acid, which theoretically gives a capture stoichiometry of one mole CO₂ to one mole ionic liquid. Despite the improved CO₂ absorption of using amine-functionalised ionic liquids, a significant drawback is the already high viscosity of the ionic liquids which further increases upon functionalising the cation and/or anion with amines, leading to slow CO₂ diffusion mass transfer and limited functionality. To address this, amine-functionalised ionic liquids are often mixed with other compounds such as water and/or other solvents to lower the viscosity. However, the presence of water or other solvents may interfere with the formation of carbamic acid and thus decrease the overall CO₂ absorption efficiency.

The present inventors have surprisingly found that amine-functionalised ionic liquids that are usually highly viscous can be efficiently absorbed and retained within swellable support particles to form an acidic gas absorbent particulate having comparatively high acidic gas uptake. Unlike porous silica, carbonized biomass such as activated carbon, and other more complex inorganic scaffold and supports, such as zeolites or metal organic frameworks (MOFs), according to at least some embodiments or examples, the acidic gas absorbent particulate described herein maintains its “dry” and “powdery” characteristics and is capable of flowing, even with the presence of the ionic liquid absorbed therein whilst also demonstrating high CO₂ uptake. Without wishing to be bound by theory, it is believed that by infusing the amine-functionalised ionic liquids into the swellable support particles, high viscosity ionic liquids can be used as the distance of diffusion of the CO₂ within the absorbed ionic liquid is reduced by the formation of small discrete microdroplets within each support particle, thus reducing the distance required for CO₂ diffusion compared to conventional scrubbing and/or solid-based scaffolds. The amine-functionalised ionic liquids may also have the advantage that the captured CO₂ is stabilized regardless of the bulk dielectric constant (unlike with conventional aqueous amine solutions where a decreasing dielectric constant with higher CO₂ sorption limits the ultimate uptake efficiency).

Additionally, given the viscosity of the amine-functionalised ionic liquid does not need to be reduced by mixing with water and/or other solvents, the amine-functionalised ionic liquids absorbed within the swellable support particles retain the ability to absorb CO₂ from gaseous streams or atmospheres via the formation of carbamic acid thus increasing the CO₂ to amine sorption ratio and overall absorption efficiency compared to conventional liquid and/or solid organic amine based absorbents utilising liquid amines or lower viscosity water/solvent mixtures comprising ionic liquids that form carbamate species with CO₂. In particular, the present inventors have found that the incorporation of the ionic liquid within the swellable support particle may, in some cases, generally improve the kinetics of acidic gas absorption and/or requires a lower desorption temperature relative to the ionic liquid on its own.

According to some embodiments or examples described herein, with regard to the preferred hydrogel support particles, their significant uptake of amine-functionalised ionic liquid whilst remaining “dry” and free-flowing with good acidic gas capture properties was not expected because: 1) hydrogel particles typically have a dry-state porosity in the low nanometre range, and in some cases a near zero “dry state” porosity. It was not expected that hydrogels—being essentially non-porous in the dry state—could be swollen with equal weight or more of viscous ionic liquid; and 2) such swelling was not expected to retain or improve the amine-functionalised ionic liquids absorption of acidic gas given the swollen pore structure of the cross-linked hydrophilic polymer forming the hydrogel particles is substantially if not completely filled (i.e. blocked) with absorbed ionic liquid. It has been surprisingly found that despite the high loading of amine-functionalised ionic liquid taking up a substantial portion and in some cases all of the available pore volume within the swollen hydrogel particles, good uptake of acidic gas is achieved. 3) the interaction of the ionic liquid with the hydrogel is also surprising since hydrogels are typically swelled with water

The amine-functionalised ionic liquid has a low vapour pressure, such that the volatility is minimised allowing for minimal loss during regeneration and recycling of the acidic gas absorbent particulate. In some embodiments, the amine-functionalised ionic liquid has a vapour pressure (in bar×10 at 25° C.) less than 1×10⁻⁵, 1×10⁻⁶, 1×10⁻⁷, or 1×10⁻⁸.

In some embodiments, the amine-functionalised ionic liquid has a high viscosity, for example a viscosity (in cP) of at least about 20, 50, 100, 200, 500, 1000, 1500, 2000, 3000, 4000, 5000, 6000, 7000, 8000, 9000 or 10,000. The viscosity may also be a range provided by any two of these values. The viscosity may be measured using any conventional method, for example via a concentric cylinder method.

In some embodiments, the components of the amine-functionalised ionic liquid are selected such that the ionic liquid is in a liquid state at the operating temperature and/or pressure when removing acidic gas from the gaseous stream or atmosphere using the acidic gas absorbent particulate. As appreciated by the person skilled in the art, the term “liquid state” refers to both a homogenous composition and a suspension or a dispersion.

In some embodiments, the amine-functionalised ionic liquid has a melting point (in ° C.) of less than about 100, 90, 80, 70, 60, 50, 40, 35, 30 or 25. In one embodiment, the amine-functionalised ionic liquid has a melting point (in ° C.) below ambient temperature. In some embodiments, the amine-functionalised ionic liquid is in a liquid state at an operating temperature (in ° C.) of at least about −80, −70, −60, −50, −40, −30, −20, −10, 0, 10, 20, 50, 70, 100, 150, 200, 250, 300 or 350. In some embodiments, the amine-functionalised ionic liquid is in a liquid state at an operating temperature (in ° C.) of less than about 350, 300, 250, 200, 150, 100, 70, 50, 20, 10, 0, −10, −20, −30, −40, −50, −60, −70 or −80. The ionic liquid may be in a liquid state at an operating temperature in a range provided by any two of these upper and/or lower values, for example is a liquid at an operating temperature (° C.) of between about 20 to 200, 20 to 180, 20 to 100, or 20 to 50. In some embodiments, the amine-functionalised ionic liquid is in a liquid state an operating pressure (in atm) of at least about 0.01, 0.1, 1, 2, 5, 10, 20, 50, 100 or 150. In some embodiments, the amine-functionalised ionic liquid is in a liquid state an operating pressure (in atm) of less than about 150, 100, 50, 20, 10, 5, 2, 1, 0.1 or 0.01. The ionic liquid may be in a liquid state at an operating pressure in a range provided by any two of these upper and/or lower values, is in a liquid state an operating pressure (in atm) of between about 0.1 to 10 or 1 to 5. In one embodiment, the amine-functionalised ionic liquid is in a liquid state at an ambient operating temperature (e.g. room temperature) and pressure (e.g. atmospheric pressure).

In one embodiment, the amine-functionalised ionic liquid may be a hydrophobic ionic liquid. Such hydrophobicity may be imparted by introducing suitable hydrophobic groups (such as long chain alkyls) at one or more sites on the cation group and/or anion group of the ionic liquid. By increasing the hydrophobicity, reduced water uptake within the acidic gas absorbent particulate may be achieved.

It will be appreciated that any suitable ionic liquid may be absorbed within the swellable support particles, provided that one or more of its components (e.g. cation and/or anion) is functionalised with one or more amine groups, as described herein. In one embodiment, the amine-functionalised ionic liquid comprises a cation group and an anion group, wherein either group is independently functionalised with one or more amines. For example, the one or more amines may be part of the anion, part of the cation of both on the cation and anion. In one embodiment, the cation group is functionalised with one or more amines. In another embodiment, the cation group is functionalised with one or more amines. In one embodiment, both the cation and anion groups are independently functionalised with one or more amines.

It will be appreciated that the anion group and cation group coordinate together to form the ionic liquid. Examples of the anion and cation groups are described herein. The amine-functionalised ionic liquid may be provided by any combination of the anion groups and cation groups as described below or herein, provided that one or more amines are present on either the cation group and/or the anion group.

### Anion Groups

The amine-functionalised ionic liquid comprises an anion group. The anion group may be functionalised with one or more amine groups. Alternatively, the anion group may not be functionalised with an amine group. It will be appreciated that where the anion group is not functionalised with an amine group, the corresponding cation group of the ionic liquid described herein is functionalised with one or more amine groups to provide the amine-functionalised ionic liquid.

In one embodiment, the anion group is selected from the group consisting of a halide, carboxylic acid, sulfonic acid, phosphonic acid or an amino acid or a derivative thereof. In one embodiment, the anion group is a carboxylic acid. In one embodiment, the carboxylic acid is lactic acid. In one embodiment, the anion group is a phosphonic acid. In one embodiment, the anion group is a sulfonic acid. In one embodiment, the anion group is a halide. In one embodiment, the anion group is an amino acid or a derivative thereof. The amino acid or derivative thereof may be selected from any of the amino acids or derivatives thereof described herein.

It will be appreciated that the acid groups form the respective conjugate base (e.g. a carboxylate, phosphonate, or sulfonate etc.) during preparation of the ionic liquid, where deprotonation of the acid species occurs upon mixing with a suitable cationic base. For example, during preparation of the ionic liquid, a polyamine may be mixed and react with a suitable anion, such as a phosphonic acid, a carboxylic acid, or sulfonic acid as described herein, that causes the protonation of the polyamine resulting in the formation of the polyamine cation and the acid is deprotonated to from the respective conjugate base as the anion (e.g. a phosphonate, carboxylate or sulfonate).

### Cation Groups

The amine-functionalised ionic liquid comprises a cation group. In one embodiment, the cation group is functionalised with one or more amine groups. Alternatively, the cation group may not be functionalised with an amine group. It will be appreciated that where the cation group is not functionalised with an amine group, the corresponding anion group of the ionic liquid described herein is functionalised with one or more amine groups to provide the amine-functionalised ionic liquid.

In one embodiment, the cation group is an onium cation group. As used herein, the term “onium cation group” refers to a cation obtained by the protonation of a mononuclear parent hydride of a pnictogen (Group 15), chalcogen (Group 16) or halogen (Group 17). The onium cation group may be selected from any suitable cation group known to the person skilled in the art so as long as an ionic liquid is formed when the anion is present with the cation and any other optional component.

In some embodiments, the onium cation group is selected from the group consisting of ammonium cation groups, phosphonium cation groups, pyridinium cation groups, imidazolium cation groups, pyrazolium cation groups, and pyrrolidinium cation groups. In one embodiment, the onium cations are quaternary onium cations. In another embodiment, the onium cations are nitrogen cations, such as ammonium cations. In another embodiment, the quaternary onium cations are quaternary nitrogen cations, for example a quaternary cations selected from ammonium cation groups, pyridinium cation groups, imidazolium cation groups, pyrazolium cation groups, and pyrrolidinium cation groups. In one embodiment, the quaternary ammonium cation group are quaternary ammonium cation groups or a quaternary phosphonium cation groups.

The onium cations may be selected from any of the onium cations of Formula 2a, 2b, 2c, or 2d:

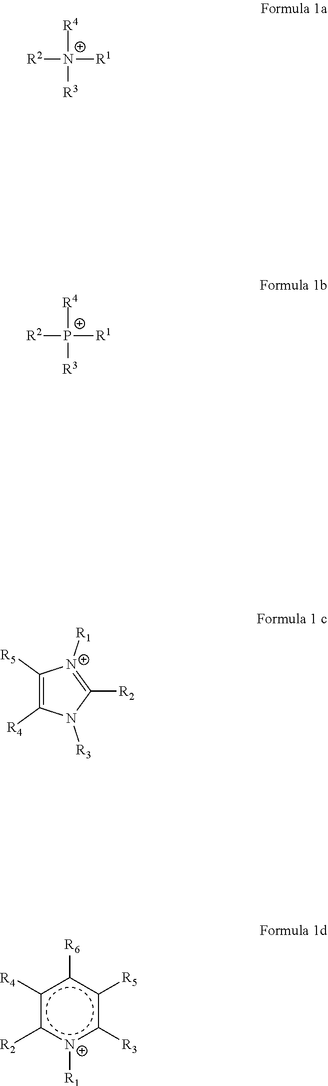

wherein
R¹, R², R³, R⁴, R⁵, and R⁶, are each independently selected from hydrogen, alkyl, alkenyl, heteroalkyl, heteroalkenyl, aryl, arylalkyl, heteroaryl, and heteroarylalkyl. and wherein two or more groups may join together to provide an aromatic or aliphatic ring Each alkyl or alkenyl may be optionally substituted, or optionally interrupted by one or more heteroatoms selected from O, N and S.

In another embodiment of any of the onium cations of Formula 1a, 1b, 1c, or 1d, the groups R¹, R², R³, R⁴, R⁵, and R⁶, are each independently selected from hydrogen, alkyl, alkenyl, heteroalkyl, heteroalkenyl, aryl, arylalkyl, heteroaryl, and heteroarylalkyl. In another embodiment the groups R¹, R², R³, R⁴, R⁵, and R⁶, are each independently selected from hydrogen, alkyl, alkenyl, heteroalkyl, and heteroalkenyl. In another embodiment, R¹, R², R³, R⁴, R⁵, and R⁶, are each independently selected from hydrogen, alkyl, and heteroalkyl. In another embodiment, R¹, R², R³, R⁴, R⁵, and R⁶, are each independently selected from hydrogen, alkyl and heteroalkyl. In another embodiment, R¹, R², R³, R⁴, R⁵, and R⁶, are each independently selected from hydrogen and alkyl. Each alkyl or alkenyl may be optionally substituted, or optionally interrupted by one or more heteroatoms selected from O, N and S.

The onium cations may be selected from any of the onium cations of Formula 1a or 1b:

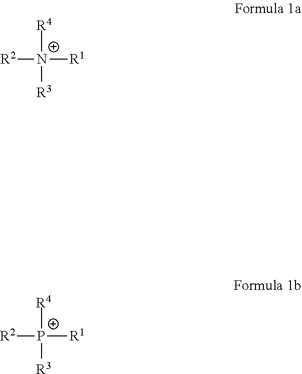

wherein
R¹, R², R³, and R⁴, are each independently selected from alkyl, alkenyl, heteroalkyl, heteroalkenyl, aryl, arylalkyl, heteroaryl, and heteroarylalkyl, and wherein two or more groups may join together to provide an aromatic or aliphatic ring. Each alkyl or alkenyl may be optionally substituted, or optionally interrupted by one or more heteroatoms selected from O, N and S.

In another embodiment of any of the onium cations of Formula 1a or 1b, the groups R¹, R², R³, and R⁴, are each independently selected from hydrogen, alkyl, alkenyl, heteroalkyl, and heteroalkenyl. In another embodiment, R¹, R², R³, and R⁴, are each independently selected from hydrogen, alkyl, and heteroalkyl. In another example, R¹, R², R³, and R⁴, are each independently selected from hydrogen and alkyl. Each alkyl or alkenyl may be optionally substituted, or optionally interrupted by one or more heteroatoms selected from O, N and S.

In one embodiment, for any of the onium cations of Formula 1a, 1b, 1c or 1d, each alkyl or alkenyl may be optionally substituted with one or more hydroxyl, carboxyl or amine, or optionally interrupted by one or more heteroatoms selected from O, N and S.

In one embodiment, the onium cation of Formula 1a is a protonated polyamine, for example a protonated diamine, triamine, tetramine and so on. It will be appreciated that a protonated polyamine comprises at least one amine group that is protonated, and any remaining amine groups remain unprotonated. In one embodiment, the diamine is 1,2-diaminopropane or ethylenediamine. In one embodiment, the triamine is diethylenetriamine. In one embodiment, the tetramine is triethylenetetramine (e.g. the onium cation group is triethylenetetrammonium). In one embodiment, the onium cation of Formula 1c is 1, 3-di (2′-aminoethyl)-2-methylimidazolium.

In one embodiment, the quaternary ammonium cations are tetraalkylammonium cation groups. In one embodiment, the quaternary phosphonium cations are tetraalkylphosphonium cation groups. Examples of suitable quaternary ammonium cations may include tetrabutylammonium, cetyltrimethylammonium, tetraethylammonium, butyltriethylammonium, tetrahexylammonium, hexyltriethylammonium, octyltriethylammonium, hexyltributylammonium, octyltributylammonium, decyltributylammonium, dodecyltributylammonium, octyltrihexylammonium, decyltrihexylammonium, dodecyltrihexylammonium, tetradecyltrihexylammonium, choline, carnitine and betaine. In one embodiment, the onium cation group is selected from the group consisting of tetrabutylammonium, cetyltrimethylammonium, tetraethylammonium, choline, carnitine and betaine. Examples of suitable quaternary phosphonium cations may include butyltriethylphosphonium, hexyltriethylphosphonium, octyltriethylphosphonium, tetrabutylphosphonium, hexyltributylphosphonium, octyltributylphosphonium, decyltrin-butylphosphonium, dodecyltributylphosphonium, octyltrihexylphosphonium, decyltrihexylphosphonium, dodecyltrihexylphosphonium, and tetradecyltri-hexylphosphonium.

In one embodiment, the cation group is hydrophobic, that is the cation group thereof comprises one or more hydrophobic groups. In one embodiment, the cation group may be a protonated amino acid or derivative thereof. The amino acid or derivative thereof may be selected from any of the amino acids or derivatives thereof described herein.

The amine-functionalised ionic liquid may be provided by any combination of anion groups and cation groups as described herein, provided that at least one of the anion group and/or cation group is functionalised with one or more amines.

### Amino Acid-Based Ionic Liquids

While the amine may be functionalised on either the cation group or the anion group, in one embodiment, at least the anion group is functionalised with one or more amine groups. The amine may be a primary, secondary or tertiary amine group. In one embodiment, the amine group forms part of an amino acid or derivative thereof.

The amino acid-based ionic liquid may be provided by any combination of anion groups and cation groups as described below or herein.

In one embodiment, the anion group may be an amino acid or a derivative thereof. Any amino acid or derivative thereof known to the person skilled in the art may be used so as long as an ionic liquid is formed when the anion is present with the cation and any optional other component.

The term “amino acid” as used herein refers broadly to any organic compound containing both a carboxyl (—COOH) and an amino (—NH₂) group, and includes naturally occurring and non-natural amino acids, as well as amino acid analogues and amino acid mimetics that function in a manner similar to the naturally occurring amino acids. Naturally encoded amino acids include the essential amino acids (alanine, arginine, asparagine, aspartic acid, cysteine, glutamine, glutamic acid, glycine, histidine, isoleucine, leucine, lysine, methionine, phenylalanine, proline, serine, threonine, tryptophan, tyrosine, and valine), including both a and β forms (e.g. α-alanine and β-alanine). Amino acid analogues refers to compounds that have the same basic chemical structure as a naturally occurring amino acid, e.g. an α-carbon that is bound to a hydrogen, a carboxyl group, an amino group, and a R group, e.g. homoserine, norleucine, methionine sulfoxide, methionine methyl sulfonium. Such analogues have modified R groups but retain the same basic chemical structure as a naturally occurring amino acid.

The term amino acid “derivative thereof” as used herein refers to any derivative of an amino acid resulting from a reaction at the amino (—NH₂), carboxyl (—COOH) and/or side-chain functional group, or from the replacement of any hydrogen by a heteroatom. As a result, the amino acid derivative may differ from the amino acid by the presence or absence of substituents. For example, an amino acid derivative that can be used as an anion in the amine-functionalised ionic liquid according to at least some embodiments or examples is taurine, which is an amino sulfonic acid. Taurine is derived from cysteine and comprises amine (—NH₂) and sulfonic acid (−S(═O)₂OH) groups. Other examples include sarcosine, isopropylglycine and betaine (which are N-alkyl derivatives of glycine) and carnitine (which is a reaction product of lysine and methionine).

Accordingly and in one embodiment, the amino acid or derivative thereof comprises at least one amine functional group and at least one functional group selected from a carboxylic acid, sulfonic acid or phosphonic acid. It will be appreciated that the acid groups of the amino acid or derivative thereof form the respective conjugate base (e.g. carboxylate, sulfonate or phosphonate) during preparation of the ionic liquid, where deprotonation of the acid species occurs upon mixing with a suitable cationic base (e.g. tetralkylammonium hydroxide, tetraalkylphosphonium hydroxide or choline hydroxide) to form the ionic liquid. It will also be appreciated that other functional groups or species may also be present on the anion (such as one or more amines which may also be protonated e.g. betaine).

In one embodiment, the anion group is selected from an amino acid, an amino sulfonic acid, or an amino phosphonic acid.

The amine functional group of the amino acid or derivative thereof may be a primary, secondary or tertiary amine group. Examples of primary amine containing amino acids or derivatives thereof include all of the essential amino acids (e.g. glycine, proline, tyrosine, isoleucine, aspartic acid) and other amino acid derivatives such as taurine. Examples of secondary and/or tertiary amine containing amino acids or derivatives thereof include N-alkylated essential amino acids (e.g. sarcosine isopropylglycine, carnitine and betaine).

In one embodiment, the amino acid or derivative thereof is selected from the group consisting of glycine, sarcosine, isopropylglycine, taurine, betaine and carnitine.

In one embodiment, the amino acid or derivative thereof is hydrophobic, that is the amino acid or derivative thereof comprises one or more hydrophobic groups. For example, the amino acid or derivative thereof may comprise one or more long alkyl chains, thus rendering the ionic liquid hydrophobic.

The cation group may be any of the cation groups described above and herein. The cation group may also be an amino acid as described herein.

### Exemplary Cation and Anion Combination Examples Forming, the Amine-Functionalised Ionic Liquid

The following Table 1 provides further specific examples of cation and anion combinations, where any of the anions can be combined with any of the cations to form the amine-functionalised ionic liquid of the present disclosure, provided that at least one of the cation group and/or anion group is functionalised with one or more amines:

TABLE 1
Anion and Cation Combination Examples

| ANIONS | CATIONS |
|---|---|
| 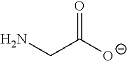 Glycine | 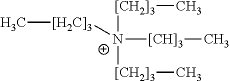 tetrabutylammonium |
| 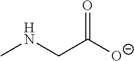 Sarcosine | 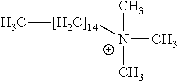 Cetyltrimethylammonium |
| 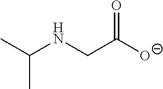 Isopropylglycine | 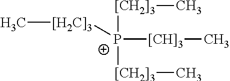 Tetrabutylphosphonium |
| 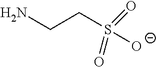 Taurine | 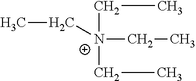 Tetraethylammonium |
| 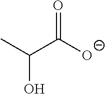 Lactic acid | 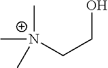 Choline |
| | 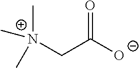 Betaine |
| | 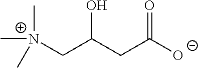 Carnitine |
| | 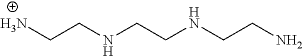 Tetraethyleneammonium |
| | 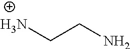 Ethylenediamine |
| | 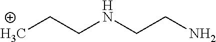 Diethylenetriamine |
| | 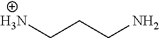 1,3-diaminopropane |

Other examples of amine-functionalised ionic liquids (including various anion groups and cation croups) suitable for absorbing within the swellable particles are disclosed in Aghaie et al. Renewable and Sustainable Energy Reviews 96; 2018; 502-525.

The amine-functionalised ionic liquid may be prepared using any known technique to the person skilled in the art. For example, an amino acid or derivative thereof and base comprising an onium cation as described herein may be mixed together for a period of time effective to dissolve the amino acid or derivative thereof. The formation of the conjugate base of the amino acid or derivative thereof generates water, which may then be removed.

### Swellable Support Particles

The acidic gas absorbent particulate comprises swellable support particles and an amine-functionalised ionic liquid absorbed within the swellable support particles. As used herein, the term “swellable support” refers to a particulate that can swell and hold a liquid, for example an amine-functionalised ionic liquid, whilst maintaining its physical structure. Importantly and unlike porous or mesoporous silica or alumina, carbonized biomass such as activated carbon, and other more complex inorganic scaffold and supports, such as zeolites or metal organic frameworks (MOFs), the swellable support particles are capable of swelling beyond its initial dry state pore volume (that is increasing in overall particle size).

According to some embodiments or examples, the swelling ability of the support helps to retain the amine-functionalised ionic liquid absorbed therein and reduce leaching, whereas conventional non-swellable porous supports can exhibit significant leaching of absorbed liquid.

The swellable support particles have a low porosity. In one embodiment, the swellable support particles do not have a dry state porosity. For example, the swellable support particles may be essentially non-porous in the dry state. When swollen with the amine-functionalised ionic liquid, the swellable support particles swell beyond the initial dry state pore volume. As a result, the porosity of the swollen support particles increases (i.e. the particles have a “liquid” based porosity). According to some embodiments or examples described herein, when swollen with an amine-functionalised ionic liquid, microdroplets of liquid within the swellable support are created, resulting in the acidic gas diffusion distance being significantly reduced allowing for enhanced sorbent uptake kinetics/efficiency, giving rise to improved performance. If the ionic liquid is removed from the swellable support particles (for example by freeze drying), the swellable support particles do not retain a measurable dry state porosity. In contrast, silica supports will take up liquid within its pores but does not swell beyond its dry state pore volume.

It will be appreciated that the embodiments described above in relation to the morphology and/or particulate size for the acidic gas absorbent particulate may equally apply for the swellable support particles.

In some embodiments, the mean average particle size (in μm) of the dry swellable support particles (e.g. prior to being swollen with the amine-functionalised ionic liquid) may be at least about 1, 5, 10, 20, 50, 100, 200, 300, 400, 500, 700, 1000, 1500, or 2000. In some embodiment, the mean average particle size (in μm) of the swellable support particles may be less than about 2000, 1500, 1000, 700, 500, 400, 300, 200, 100, 50, 20, 10, 5 or 1. The mean average particle size of the swellable support particles may be in a range provided by any two of these upper and/or lower values, for example the mean average particle size (in μm) may be between about 10 to 2000, 10 to 1000, or 10 to 500. Swellable support particles may provide one or more advantages, including for example an increased surface area for greater contact and subsequent absorption of acidic gas.

In some embodiments, the dry state pore size of the swellable support particles (i.e. the pore size prior to being swollen with amine-functionalised ionic liquid) may be in the nanometer range, for example, a median pore diameter of less than about 20 nm, and in some cases may not have a measurable dry state porosity (e.g. where the support particles are a hydrogel particulate, such as particles of cross-linked polyethylenimine). In one example, the swellable support particles are hydrogel particles having a pore diameter of less than 5 nm, for example between about 0.01 nm to about 2 nm.

The swellable support particles are capable of absorbing and retaining a high amount of liquid (such as an amine-functionalised ionic liquid) relative to its mass, due to being able to swell beyond its initial dry state pore volume. In some embodiments, the swellable support particles are generally capable of absorbing anywhere from at least 1 times its own weight in fluid (e.g. for a cellulose based support such as saw dust or wood flour) up to about 300 times its own weight in fluid (e.g. for a hydrogel based support). The surface area within the swellable support particles may increase or decrease depending on the degree of swelling. For example, the amine-functionalised ionic liquid can swell the support into a more open mobile structure with liquid-filled pores which may increase the accessibility of acidic gases (e.g. CO₂ or H₂S) to the reactive functional amine groups of the amine-functionalised ionic liquid. Depending on the type of swellable support, the swelling capacity (sometimes referred to as the maximum swelling capacity) may vary, which essentially defines the swelling limit of the support particles.

The swellable support particles have a swelling capacity (i.e. is capable of absorbing liquid). The typical method to determine this is by taking a known weight of the dry support particles (e.g. dried wood flour or dried hydrogel particles etc.) and swelling in an excess of liquid for a specified period of time (typically 48 hours). After which time any excess liquid is removed by filtration and the swellable support particles weight is recorded to determine the swelling ratio. The mass difference between the dry and swollen state of the support particles correspond to the amount of the absorbed liquid, which is then calculated as a grams of liquid per gram of swellable support particles (g/g). In one embodiment, the swelling capacity of the support is measured with reference to the amine-functionalised ionic liquid described herein.

In some embodiments, the swellable support particles may have an amine-functionalised ionic liquid swelling capacity (in (g/g)) of at least about 0.5, 1, 5, 10, 20, 30, 40, 50, 60, 70, 80, 90, 100, 150, or 200. In other embodiments, the swellable support particles may have an amine-functionalised ionic liquid swelling capacity (in (g/g)) of less than about 200, 150, 100, 90, 80, 70, 60, 50, 40, 30, 20, 10, 5, 1 or 0.5. The swelling capacity may be a range provided by any two of these upper and/or lower values, for example the swellable support particles may have an amine-functionalised ionic liquid swelling capacity (in (g/g)) of between about 20 to about 100.

In one embodiment, the amount of amine-functionalised ionic liquid absorbed within the swellable support particles does not exceed the swelling capacity of the swellable support particles. According to some embodiments or examples, by not exceeding and/or operating below the swellable support particles swelling capacity, the acidic gas absorbent particulate exhibits “dry” and “powdery” characteristics and is capable of flowing, even with the presence of the ionic liquid absorbed therein. By ensuring that the amount of absorbed ionic liquid, and any moisture from the gaseous stream that may also be absorbed when in use, is at or near the particles swelling capacity whilst not exceeding the same, the amount of ionic liquid within each particle can be maximised to allow for increased acidic gas absorption, whilst retaining the particulates “dry” and “powdery” characteristics.

The swellable support particles are capable of swelling and retaining the amine-functionalised ionic liquid within the support. The amine-functionalised ionic liquid may be strongly or weakly bound to the matrix network within the support particles or may be non-bound. The amount of amine-functionalised ionic liquid in the swellable support particles can vary depending on the degree of swelling and/or dehydration of the support material. In some embodiments, the swellable support particles may comprise (in wt. %) at least about 0.5, 1, 5, 10, 20, 30, 40, 50, 60, 70, 80, 90, or 95 of amine-functionalised ionic liquid based on the total weight of the acidic gas absorbent particulate (e.g. the weight of the swellable support and any ionic liquid absorbed therein). In some embodiments, the swellable support particles may comprise (in wt. %) less than about 95, 90, 80, 70, 60, 50, 40, 30, 20, 10, 5, 1, or 0.5 of amine-functionalised ionic liquid based on the total weight of the acidic gas absorbent particulate. The amount of amine-functionalised ionic liquid swollen within the support particles may be a range provided by any two of these upper and/or lower values, for example the swellable support particles may comprise (in wt. %) between about 5 to 95, 10 to 95 or 40 of amine-functionalised ionic liquid based on the total weight of the acidic gas absorbent particulate.

In some embodiments, the ratio the % w/w ratio of amine-functionalised ionic liquid to swellable support particles in the acidic gas absorbent particulate may be at least about 1:5, 1:4, 1:3, 1:2, 1:1, 1.5:1, 2:1, 2:5:1, 3:1, 3.5:1, 4:1, 4.5:1 or 5:1 based on the total weight of the acidic gas absorbent particulate. In some embodiments, the ratio the % w/w ratio of amine-functionalised ionic liquid to swellable support particles in the acidic gas absorbent particulate may be less than about 5:1, 4.5:1, 4:1, 3.5:1, 3:1, 2.5:1, 2:1, 1.5:1, 1:1, 1:2, 1:3, 1:4 or 1:5 based on the total weight of the acidic gas absorbent particulate. The % w/w ratio of amine-functionalised ionic liquid to swellable support particles may be a range provided by any two of these upper and/or lower values, for example the % w/w ratio of amine-functionalised ionic liquid to swellable support particles in the acidic gas absorbent may be between about 1:1 to 5:1, 1:1 to 3:1 or 1:1 to 2.5:1 based on the total weight of the acidic gas absorbent material.

According to some embodiments or examples, a % w/w ratio of amine-functionalised ionic liquid to swellable support particles of between about 1:1 to 3:1 provides one or more advantages, including maximising the amount of reactive amines for capture of the acidic gas (e.g. CO₂ via formation of carbamic acid) present within the swollen support particles whilst maintaining the powdery “dry” characteristics of the support particles, which allows them to flow for example in a fluidised bed reactor.

The surface area of the swellable support particles can vary depending on their morphology and/or size. In some embodiments, the swellable support particles may have a surface area (in m² per gram of swellable support (m²/g)) of at least about 0.1, 0.2, 0.5, 0.7, 1, 2, 3, 4, 5, 6, 7, 8, 9, 10, 15, 20, 25, 30, 35, 40, or 50. In some embodiments, the swellable support particles may have a surface area (in m²/g) of less than about 50, 45, 40, 35, 30, 25, 20, 15, 10, 9, 8, 7, 6, 5, 4, 3, 2, or 1. The surface area may be in a range provided by any two of these upper and/or lower values, for example the swellable support particles may have a surface area (in m²/g) of between about 0.1 to 40, 0.1 to 10, or 0.1 to 5. In one embodiment, the surface area (in m²/g) is measured using gas sorption with nitrogen or particle size analysis through microscopy, for example is the BET surface area, and may be provided for the swellable support particles in a wet or dry state.

The swellable support particles may be any suitable material capable of swelling and retaining the amine-functionalised ionic liquid within the support. In some embodiments, the swellable support particles comprise a hydrogel or a cellulose material, or a combination thereof.

### Cellulose Material Supports

In one embodiment, the swellable support particles comprise a cellulose material. As used herein, the term “cellulose material” refers to a support that comprises the polysaccharide cellulose or a derivative thereof as an organic component, which exhibits the ability to swell and retain within its structure the amine-functionalised ionic liquid without dissolving. For example, wood is a form of cellulose, with cellulose being the chief substance composing the cell walls or woody part of plants. In another example, carboxymethyl cellulose is a cellulose derivative with carboxymethyl groups bound to some of the hydroxyl groups of the glucopyranose monomers that make up the cellulose backbone. In one embodiment, the cellulose material is a wood based material or a synthetic cellulose material, or a combination thereof.

In some embodiments, the cellulose material is a wood based material. The wood based material may be selected from the group consisting of saw dust, wood flour, wood dust or sander fines, or a combination thereof. Saw dust is a particulate by-product or waste of woodworking operations, such as sawing. Wood flour is a pulverized dried wood particulate from either soft or hard wood waste. Wood dust is wood in a fine or powdered particulate condition. Sander fines are dust-like, minute wood particles. The wood based material may be a commercially available chemical spill kit.

In some embodiments, the synthetic cellulose material is selected from the group consisting of methyl cellulose, hydroxyethyl methyl cellulose, hydroxypropyl methyl cellulose, hydroxyethyl cellulose, hydroxypropyl cellulose, and carboxymethyl cellulose, or a combination thereof.

It will be appreciated that the embodiments described herein in relation to the swellable support particles generally, equally apply to the cellulose material support particles.

### Hydrogel Supports

In one embodiment, the swellable support particles comprise a hydrogel. The term “hydrogel” refers to a three-dimensional (3D) network of cross-linked hydrophilic polymers that can swell and hold a large amount of water and other liquids while maintaining the structure due to chemical or physical cross-linking of individual hydrophilic polymer chains. The hydrogel comprises a cross-linked hydrophilic polymer. The absorbed water/liquid is taken into the cross-linked hydrophilic polymeric matrix of the hydrogel through hydrogen bonding rather than being contained in pores from which the fluid could be eliminated by squeezing. Unlike other more complex inorganic scaffolds and supports, such as zeolites or metal organic frameworks (MOFs), after removing the solvent the hydrogel does not retain a measurable dry state porosity.

The surprisingly high uptake of amine-functionalised ionic liquid within the hydrogel particles, which in some cases includes at least equal weight of absorbed ionic liquid, whilst retaining free-flowing properties is understood to be due to the significant swelling of the hydrogel in the presence of the amine-functionalised ionic liquid. For example, the dry state porosity of the hydrogel particles is low (and often not measurable), so when the amine-functionalised ionic liquid swells into the hydrogel, it is believed to be highly dispersed within molecular size “pores” which increase in size as the hydrogel swells thus increasing the uptake of ionic liquid absorbed therein. Additionally, microdroplets of amine-functionalised ionic liquid may be dispersed throughout the cross-linked hydrophilic polymer forming the hydrogel which increases the contact area between the acidic gas and the amine functional groups of the ionic liquid and can result in the acidic gas diffusion distance being significantly reduced allowing for enhanced sorbent uptake kinetics/efficiency, giving rise to improved performance. In one embodiment, the hydrogel particles are in the form of a free-flowing powder. In a related embodiment, the hydrogel particles are flowable.

It will be appreciated that the embodiments described herein in relation to the swellable support particles generally, equally apply to the hydrogel support particles. The hydrogel particles may have a roughened or textured surface which can provide an enhanced surface area which can facilitate the absorption of the ionic liquid within the surface of the hydrogel, by increasing the surface area. The surface roughness may be provided by crushing/grinding the hydrogel into particles, wherein the particles comprise a roughened surface.

The hydrogel may be characterised by an elastic modulus. For example, the hydrogel may have an elastic modulus (in Pa) of at least about 0.1, 10, 30, 50, 100, 200, 500, 1,000, 2,000, 5,000, 8,000, 10,000 or 12,000. The hydrogel may have an elastic modulus (in Pa) of less than about 12,000, 10,000, 8,000, 5,000, 2,000, 1,000, 500, 200, 100, 50, 30, 10, or 0.1. The elastic modulus (in Pa) may be in a range provided by any two of these upper and/or lower values, for example between about 0.1 to 12,000, 100 to 5,000, or 2,000 to 5,000.

The elastic modulus may be determined by a number of suitable techniques, including using a rheometer, for example a HR-3 Discovery Hybrid Rheometer (TA Instruments). A Rheometer can be used to control shear stress or shear strain and/or apply extensional stress or extensional strain and thereby determine mechanical properties of a hydrogel including the modulus of elasticity thereof.

The hydrophilic polymer of the hydrogel is selected to provide suitable mechanical and chemical properties to the hydrogel. For example, in some embodiments, the hydrogel may need to be able to withstand various shear and stress environments, such as when in contact with the gaseous stream or atmosphere and/or dry or moist/humid environments. In some embodiments, the hydrogel may also need to withstand a wide temperature range, for example when undergoing thermal regeneration.

In some embodiments, the hydrogel may also need to be physically robust so that it can be introduced into various gas flowlines as a flow of particulate material or so that the particulate material can be provided in a packed bed with sufficient interstitial space between adjacent particles to allow a flow of gas or atmosphere therethrough. In some embodiments, the cross-linked hydrophilic polymer is also chemically inert. Accordingly, one or more of these properties may be provided by the appropriate selection of the hydrophilic polymer.

In some embodiments, the hydrogel comprises (in % w/w) at least about 0.01, 0.05, 0.1, 0.2, 0.5, 1, 2, 5, 10, 15, 20, 25, 30, 35, 40, 45, or 50 hydrophilic polymer based on the total weight of the hydrogel. In some embodiments, the hydrogel comprises (in % w/w) less than about 50, 45, 40, 35, 30, 25, 20, 15, 10, 5, 2, 1, 0.5, 0.2, 0.1, 0.05 or 0.01 hydrophilic polymer based on the total weight of the hydrogel. The % w/w of hydrophilic polymer may be in a range provided by any two of these upper and/or lower values, for example between about 0.05 to 50, 1 to 50, 0.05 to 25, 10 to 50, 10 to 40, or 30 to 50 based on the total weight of the hydrogel.

In some embodiments, the hydrophilic polymer has a weight average molecular weight (Mw in g/mol) of at least about 1,000, 5,000, 10,000, 50,000, 100,000, 150,000, 200,000, 250,000 or 500,000. In some embodiments, the hydrophilic polymer has a weight average molecular weight (Mw in g/mol) of less than about 500,000, 250,000, 200,000, 150,000, 100,000, 50,000, 10,000, 5,000 or 1,000. The molecular weight (Mw in g/mol) may be in a range provided by any two of these upper and/or lower values, for example between about 100 to 500,000, 1,000 to 250,000, 5,000 to 50,000, or 10,000 to 30,000. It will be appreciated that these weight average molecular weights are provided for the hydrophilic polymer prior to cross-linking. It will be appreciated that the weight average molecular weight of the hydrophilic polymer may vary depending on the type used to prepare the hydrogel. In one embodiment, the hydrophilic polymer may comprise a homopolymer or a copolymer. The weight average molecular weight can be determined using a variety of suitable techniques known to the person skilled in the art, for example gel permeation chromatography (GPC), size-exclusion chromatography (SEC) and light scattering. In one embodiment, the weight average molecular weight is determined by size-exclusion chromatography (SEC).

In one embodiment, the Mw is determined using size exclusion chromatography (SEC) by passing a solution of the hydrophilic polymer through a suitable column comprising a gel that separates the hydrophilic polymer based on molecular size (i.e. hydrodynamic volumes which can be correlated with molecular weight), with larger size molecules (larger Mw) eluting first followed by smaller size molecules (smaller Mw). This can be performed in a suitable organic solvent or in aqueous media. The Mw is typically determined against a series of known polymer standards or using molar mass sensitive detectors. Suitable protocols for determining molecular weight of the hydrophilic polymer are outlined in “Size-exclusion Chromatography of Polymers” Encyclopaedia of Analytical Chemistry, 2000, pp 8008-8034, incorporated herein by reference.

In one embodiment, the hydrogel comprises a thermally conductive particulate material interspersed on or within the hydrogel. By incorporating thermally conductive particulate material (e.g. carbon-based particulate materials (e.g. graphite, carbon black)) within the hydrogel, the effective thermal conductivity can be improved, whilst maintaining good regeneration.

In some embodiments, the hydrogel comprises a cross-linked polyamine, a cross-linked polyacrylamide, or a cross-linked polyacrylate, derivative or copolymer thereof. In one embodiment, the hydrogel comprises a cross-linked polyamine or a cross-linked polyacrylamide, or a derivative or copolymer thereof.

### Polyamines

In one embodiment, the hydrophilic polymer may comprise a polyamine, derivative or a copolymer thereof. As understood in the art, a polyamine is an organic compound having two or more amine groups (e.g. primary —NH₂, secondary —NHR, and/or tertiary —NR₂ amine groups).

In some embodiments, the hydrophilic polymer may comprise a liner, branched, or dendritic polyamine, derivative or copolymer thereof. The polyamine, derivative or copolymer thereof can be cross-linked by one or more cross-linking agents described herein.

In one embodiment, the polyamine, derivative or copolymer thereof is a polyalkylenimine. The polyalkylenimine may be selected from the group consisting of polyethylenimine, polypropylenimine, and polyallylamine, derivatives or copolymers thereof. Suitable polyamines that can be used to form the hydrogel may include polyethylenimine, polypropylenimine, and polyallylamine. In one embodiment, the hydrophilic polymer comprises polyethylenimine or a copolymer thereof. By using a hydrogel comprising a cross-linked polyamine (such as polyethylenimine), the hydrogel comprises a plurality of primary and secondary amine functional groups which are capable of reacting and binding to an acidic gas (e.g. CO₂ or H₂S) upon contact with a gaseous stream or atmosphere comprising the acidic gas, thus enhancing acidic gas absorption efficiency.

### Polyacrylamides

In some embodiments or examples, the hydrophilic polymer may comprise a polyacrylamide, derivative or copolymer thereof. As understood in the art, a polyacrylamide, derivative or copolymer is an organic compound having two or more acrylamide units. In some embodiments or examples, the polyacrylamide, derivative or copolymer thereof, may comprise copolymerisable hydrophilic monomers comprising at least two acrylamide or acrylamide derivatives to form a polyacrylamide, derivative or copolymer thereof. In another embodiment or example, the polyacrylamide copolymer, may comprise copolymerisable hydrophilic monomers comprising at least one acrylamide or acrylamide derivative and at least one carboxylic acid derivative to form a polyacrylamide copolymer.

The acrylamide derivative may be selected from N-alkyl, N-hydroxyalkyl, or N,N-dialkyl substituted acrylamide or methacrylamide. In some embodiments or examples, the polyacrylamide derivative may be selected from the group comprising N-acrylamide, methylacrylamide, N-ethylacrylamide, N-isopropylacrylamide (NiPAAm), N-octylacrylamide, N-cyclohexylacrylamide, N-methyl-N-ethylacrylamide, N-methylmethacrylamide, N-ethylmethacrylamide, N-isopropylmethacrylamide, N, N-dimethylacrylamide, N,N-diethylacrylamide, N,N-dimethylmethacrylamide, N, N-diethylmethacrylamide, N,N-dicyclohexylacrylamide, N-methyl-N-cyclohexylacrylamide, or combinations thereof. In an embodiment or example, the arylamide derivative may be selected from methacrylamide, dimethylacrylamide, N-isopropylacrylamide. N,N′-methylene-bis-acrylamide, N-2-hydroxyethylacrylamide, or combinations thereof.

The carboxylic acid derivative may be selected from the group comprising acrylic acid, methacrylic acid, methyl methacrylate, sodium acrylate, potassium acrylate, sodium methacrylate, potassium methacrylate, 2-hydroxyethyl methacrylate (HEMA), or combinations thereof.

In one embodiment or example, the acrylamide or acrylamide derivatives used in the preparation of the polyacrylamide or polyacrylamide derivative may be the same. In another embodiment or example, the acrylamide or acrylamide derivative used in the preparation of the polyacrylamide copolymer may be different. In yet another embodiment, at least one acrylamide or acrylamide derivative and at least one carboxylic acid derivative may be used in the preparation of the polyacrylamide copolymer.

In some embodiments or examples, the polyacrylamide, derivative, or copolymer thereof may be selected from the group comprising or consisting of polyacrylamide, poly(methacrylamide), poly(N-2-hydroxyethyl)acrylamide, poly(dimethylacrylamide), poly(ethylacrylamide), poly(diethylacrylamide), poly(isopropylacrylamide), poly(methylmethacrylamide), poly(ethylmethacrylamide), poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly (acrylamide-co-methylenebisacrylamide).

In some embodiments or examples, the polyacrylamide, derivative or copolymer thereof may be selected from the group comprising or consisting of polyacrylamide, poly(methacrylamide), poly(dimethylacrylamide), poly(isopropylacrylamide), poly(acrylamide-co-acrylic acid), poly(acrylic acid-co-maleic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly(acrylamide-co-methylenebisacrylamide). In some embodiments or examples, the polyacrylamide copolymer may be selected from the group comprising or consisting of poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly(acrylamide-co-methylenebisacrylamide).

In some embodiments, the polyacrylamide, derivative, or copolymer thereof is poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt, and poly(acrylamide-co-methylenebisacrylamide). In one embodiment, the polyacrylamide, derivative, or copolymer thereof is poly(acrylamide-co-acrylic acid),

The polyacrylamide, derivative, or copolymer thereof can be cross-linked by one or more cross-linking agents as described herein, For example, the polyacrylamide may be cross-linked with N, N-methylenebisacrylamide or ethyleneglycol dimethacrylate via a free-radical initiated vinyl polymerization mechanism. In one embodiment, the cross-linked hydrophilic polymer is poly(acrylamide-co-methylenebisacrylamide) or poly(acrylamide-co-ethyleneglycol dimethacrylate). The polyacrylamide, derivative, or copolymer thereof may also be cross-linked with an aldehyde, for example formaldehyde or glutaraldehyde.

In some embodiments, the hydrogel comprising cross-linked polyacrylamide, derivative, or copolymer thereof, may further comprise one or more metal salts. Suitable metal salts include sodium salts or potassium salts.

### Polyacrylates

In some embodiments or examples, the hydrophilic polymer may comprise a polyacrylate, derivative or copolymer thereof. As understood in the art, a polyacrylate, derivative or copolymer is an organic compound having two or more acrylate units. In some embodiments or examples, the polyacrylate, derivative or copolymer thereof, may comprise copolymerisable hydrophilic monomers comprising at least two acrylate or acrylate derivatives to form a polyacrylate, derivative or copolymer thereof.

The acrylate derivative may be selected from acrylate, sodium acrylate, potassium acrylate, methacrylate, sodium methacrylate, potassium methacrylate, methyl methacrylate, 2-hydroxyethyl methacrylate (HEMA), 2-hydroxyethyl acrylate (HEA), N-isopropylacrylamide, or combinations thereof.

In some embodiments, the polyacrylate, derivative or copolymer thereof may be selected from the group comprising or consisting of poly(2-hydroxyethyl methacrylate) (pHEMA), poly(2-hydroxyethyl acrylate) (pHEA), or poly(sodium acrylate). In one embodiment, the polyacrylate, derivative or copolymer thereof may be selected from the group comprising or consisting of poly(2-hydroxyethyl methacrylate) (pHEMA) or poly(2-hydroxyethyl acrylate) (pHEA). In one embodiment, the polyacrylate, derivative or copolymer thereof is poly(2-hydroxyethyl methacrylate) (pHEMA). In one embodiment, the polyacrylate, derivative or copolymer thereof is poly(2-hydroxyethyl acrylate) (pHEA).

### Polyacrylic Acids

In some embodiments or examples, the hydrophilic polymer may comprise a polyacrylic acid, derivative or copolymer thereof. As understood in the art, a polyacrylic acid, derivative or copolymer is an organic compound having two or more acrylic acid units. In some embodiments or examples, the polyacrylic acid, derivative or copolymer thereof, may comprise copolymerisable hydrophilic monomers comprising at least two acrylic acid or acrylic acid derivatives to form a polyacryclic acid, derivative or copolymer thereof.

The acrylic acid derivative may be selected from acrylic acid or methacrylic acid, In some embodiments, the polyacryclic acid, derivative or copolymer thereof may be poly(acrylic acid) or poly(methacrylic acid).

In some embodiments, the hydrogel comprises a cross-linked hydrophilic polymer selected from the group consisting of poly(methacrylamide), poly(dimethylacrylamide), poly(ethylacrylamide), poly(diethylacrylamide), poly(isopropylacrylamide), poly(methylmethacrylamide), poly(ethylmethacrylamide, polyacrylamide, poly(acrylamide-co-acrylic acid), poly(acrylamide-co-sodium acrylate), poly(acrylamide-co-potassium acrylate), poly(acrylamide-co-acrylic acid) partial potassium salt, poly(acrylamide-co-acrylic acid) partial sodium salt and poly (acrylamide-co-methylenebisacrylamide), polyethylenimine, polypropylenimine, polyallylamine, poly(2-hydroxyethylmethacrylate) or poly(2-hydroxyethyl acrylate), or a derivative or copolymer thereof.

In some embodiments, the hydrogel comprises a cross-linked hydrophilic polymer selected from the group consisting of polyamine, polyacrylate, polyacrylic acid, polyacrylamide or polyacrylamide-co-acrylic acid, polyacrylamide-co-acrylic acid partial sodium salt, polyacrylamide-co-acrylic acid partial potassium salt, poly(acrylic acid-co-maleic acid), poly(N-isopropylacrylamide), polyethylene glycol, polyethyleneimine, polypropylenimine, polyallylamine and vinylpyrrolidone, or a derivative or copolymer thereof. Alternatively, the hydrogel may comprise cross-linked natural hydrophilic polymers, for example polysaccharides, chitin, polypeptide, alginate or cellulose. Other suitable cross-linked hydrophilic polymers are described herein, for example polyamines, polyacrylates, polyacrylic acids or polyacrylamides, derivatives or copolymers thereof.

### Cross-Linker and Cross-Linking Agent

The hydrogel comprises a cross-linked hydrophilic polymer. It will be understood that some degree of cross-linking of the hydrophilic polymer is required to form the hydrogel. The rigidity and elasticity of the hydrogel can be tailored by altering the degree of cross-linking. The cross-linker promotes the formation of the 3D polymeric network, making it insoluble. The insolubilized cross-linked polymeric network allows for the adoption and retention of water and other liquids. An overview of cross-linked hydrogels is discussed in Maitra et al., American Journal of Polymer Science, 2014, 4(2), 25-31, which is incorporated herein by reference.

As used herein, the term “cross-link, “cross-linked” or “cross-linking” refers to the formation of interactions within or between hydrogel-forming polymers which result in the formation of a three-dimensional matrix. i.e. a hydrogel. For example, a polyamine may be cross-linked by 1, 3-butadiene diepoxide (BDDE) or triglycidyl trimethylolpropane ether (TTE or TMPTGE) to form a cross-linked polyamine hydrogel.

In some embodiments, the hydrophilic polymer comprises about 0.01 mol % to about 50 mol % cross-linking agent. The hydrophilic polymer may comprise at least about 0.01, 0.1, 1, 2, 5, 10, 15, 20, 25, 30, 35, 40, 45, or 50 mol % cross-linking agent. The hydrophilic polymer may comprise less than about 50, 45, 40, 35, 30, 25, 20, 15, 10, 5, 2, 1, 0.1 or 0.01 mol % cross-linking agent. Combinations of these mol % values to form various ranges are also possible, for example the hydrophilic polymer may comprise between about 0.01 mol % to about 50 mol %, about 0.01 mol % to about 20 mol %, or about 0.01 mol % to about 10 mol % cross-linking agent.

In some embodiments, the hydrogel comprises between about 1% w/w to about 20% w/w cross-linking agent based on the total weight of the hydrogel. In some embodiments, the hydrogel comprises at least about 1, 2, 3, 4, 5, 6, 8, 10, 15 or 20 wt. % cross-linking agent based on the total weight of the hydrogel. In other embodiments, the hydrogel comprises less than about 20, 15, 20, 15, 10, 8, 6, 5, 3, 2, or 1% w/w cross-linking agent based on the total weight of the hydrogel. Combinations of these % w/w values to form various ranges are also possible, for example the hydrogel in a non-swollen state comprises between about 1% w/w to about 10% w/w, or between about 1% w/w to about 6% w/w cross-linking agent based on the total weight of the hydrogel.

Accordingly, in some embodiments, the hydrogel comprises between about 0.05% w/w to about 50% w/w cross-linked hydrophilic polymer based on the total weight of the hydrogel. In some embodiments, the hydrogel comprises at least about 0.01, 0.05, 0.1, 0.2, 0.5, 1, 2, 5, 10, 15, 20, 25, 30, 35, 40, 45, or 50% w/w cross-linked hydrophilic polymer based on the total weight of the hydrogel. In other embodiments, the hydrogel comprises less than about 50, 45, 40, 35, 30, 25, 20, 15, 10, 5, 2, 1, 0.5, 0.2, 0.1, 0.05 or 0.01% w/w cross-linked hydrophilic polymer based on the total weight of the hydrogel. Combinations of these cross-linked hydrophilic polymer to form various ranges are also possible, for example the hydrogel comprises between about 0.01% w/w to about 50% w/w, about 0.05% w/w to about 50% w/w, about 1% w/w to about 50% w/w, about 0.05 wt. % to about 25% w/w, about 10% w/w to about 50% w/w, about 10% w/w to about 40 wt. %, or about 30% w/w to about 50% w/w cross-linked hydrophilic polymer based on the total weight of the hydrogel.

The swelling ability of the hydrogel is dependent on the nature of the cross-linked hydrophilic polymer and the amine-functionalised ionic liquid that is swelling the hydrogel. For example, a hydrogel with long hydrophilic cross-links may swell more than an analogous cross-linked polymer network with shorter hydrophobic cross-links.

In some embodiments, the cross-linking agent is an epoxide (i.e. an epoxide cross-linker). For example, the epoxide can provide a bivalent or polyvalent linking group in the cross-linked hydrophilic polymer, which may comprise one or more hydroxyl groups arising from reaction of the epoxide groups with the hydrophilic polymer. In some embodiments, the cross-linking agent comprises at least 1, 2, 3, 4 or 5 epoxides. In some embodiments, the cross-linking agent comprises 2 epoxides. In one embodiment, the cross-linking agent is an epoxide. In one embodiment the epoxide is a diepoxide (e.g. comprises 2 epoxide groups, for example BDDE). In one embodiment, the epoxide is a triepoxide (e.g. comprises 3 epoxide groups, for example TTE). In one embodiment, the cross-linking agent is 1, 3-butadiene diepoxide (BDDE) or triglycidyl trimethylolpropane ether (TTE or TMPTGE). In some embodiments, the hydrogel comprises a cross-linked polyamine or copolymer thereof. In some embodiments, the hydrogel comprises a cross-linked polyacrylamide or co-polymer thereof. In some embodiments, the hydrogel comprises a cross-linked polyamine or a cross-linked polyacrylamide, or copolymers thereof.

The cross-linking agent may be selected from the group consisting of triglycidyl trimethylolpropane ether (TTE or TMPTGE) (also referred to as trimethylolpropane triglycidyl ether), diglycidyl ether, Resorcinol diglycidyl ether (CAS Number: 101-90-6), Bisphenol A diglycidyl ether, 1, 3-Butadiene diepoxide, Diglycidyl 1,2-cyclohexanedicarboxylate, Diglycidyl hexahydrophthalate, Poly(ethylene glycol) diglycidyl ether average (<Mn 1000), Glycerol diglycidyl ether, 1,4-Butanediol diglycidyl ether, Bisphenol F diglycidyl ether, Bisphenol A propoxylate diglycidyl ether, Bisphenol A propoxylate diglycidyl ether PO/phenol 1, N,N-Diglycidyl-4-glycidyloxyaniline, N,N-Diglycidyl-4-glycidyloxyaniline, Poly(dimethylsiloxane), diglycidyl ether terminated (Mn<1000), Neopentyl glycol diglycidyl ether, 2,2-Bis[4-(glycidyloxy)phenyl]propane, 4,4′-Isopropylidenediphenol diglycidyl ether, BADGE, Bisphenol A diglycidyl ether, D.E.R.™ 332, Bis[4-(glycidyloxy)phenyl]methane, Tris(4-hydroxyphenyl)methane triglycidyl ether, Tris(2,3-epoxypropyl) isocyanurate, 4,4′-Methylenebis(2-methylcyclohexylamine).

Other suitable cross linking agents may also comprise one or more isothiocyanates, isocyanates, acyl azides, NHS esters, sulfonyl chlorides, aldehydes, glyoxals, epoxides, oxiranes, carbonates, aryl halides, imidoesters, carbodiimides, anhydrides, acrylates, acrylamides, diamines, and fluorophenyl ester groups.

The cross-linking agent may comprise an aldehyde group, for example at least one, two, or three aldehyde groups. For example, the cross-linking agent may be formaldehyde or glutaraldehyde. In one embodiment, the hydrophilic polymer is a polyacrylamide, derivative, or copolymer thereof cross-linked with an aldehyde, for example formaldehyde or glutaraldehyde.

The cross-linking agent may comprise two or more vinyl groups (—C═CH₂). For example, the cross-linking agent may be a divinyl cross-linking agent, such as N, N-methylenebisacrylamide or ethyleneglycol dimethacrylate. In some embodiments, the hydrophilic polymer is a polyacrylamide, derivative, or copolymer thereof, cross-linked with N, N-methylenebisacrylamide via a free-radical initiated vinyl polymerization mechanism, for example to form a poly(acrylamide-co-methylenebisacrylamide) hydrogel or poly(N-2-hydroxethyl)acrylamide hydrogel that is held together by covalent bonds.

In some embodiments, a free radical initiator and/or catalyst may be added to initiate/catalyse the radical polymerisation. Suitable catalysts include diamines, such as N,N,N′N′-tetramethyldiaminomethane, N,N,N′,N′-tetraethylmethanediamine, N,N,N′,N′-tetramethyl-1,3-propanediamine, or N,N,N′,N′-tetramethyl-1,4-butanediamine. Suitable initiators include peroxysulfates, peroxyphosphates, peroxycarbonates, alkyl peroxides, acyl peroxides, hydroperoxides, ketone peroxides, peresters, azo compounds, azides, etc., e.g., diethyl peroxydicarbonate, ammonium persulfate, potassium persulfate, potassium peroxyphosphate, t-butyl peroxide, acetyl peroxide, t-butyl hydroperoxide, methyl ethyl ketone peroxide, dimethylperoxalate, azo-bis(isobutyronitrile), benzenesulfonylazide, 2-cyano-2-propyl-azo-formamide, azo-bisisobutyramidine dihydrochloride (or as free base), azobis-(N,N′-dimethyleneisobutyramidine-dihydrochloride (or as free base), and 4,4′-azo-bis(4-cyanopentanoic acid).

In some embodiments, the cross-linking agent is a diacrylate or a diacrylamide.

Other examples of suitable cross-linking agents include ethylene glycol dimethacrylate, piperazine diacrylamide, PEG diacrylate, ethyleneglycol dimethacrylate, diethyleneglycol diacrylate, triethyleneglycol diacrylate.

In one embodiment, the cross-linked hydrophilic polymer comprises poly(acrylamide-co-acrylic acid) or a partial sodium or potassium salt thereof, that is cross-linked with 1-ethyl-3-(3-dimethylaminopropyl)carbodiimide (EDC) and N-hydroxysuccinimide (NHS) and multifunctional amines.

### Process for Preparing Acidic Gas Absorbent

The present disclosure also provides a process for preparing the acidic gas absorbent particulate. In one embodiment, the process comprises contacting an amine-functionalised ionic liquid with swellable support particles under conditions effective to absorb the amine-functionalised ionic liquid within the swellable support particles.

Any suitable means of contacting may be used, for example mixing, immersing, sonication etc. of the amine-functionalised ionic liquid with the swellable support particles.

The swellable support particles and amine-functionalised ionic liquid may be contacted (i.e. combined or mixed) at a suitable temperature effective for the support to absorb and swell with the ionic liquid.

In one embodiment, the amine-functionalised ionic liquid and swellable support particles is heated at a temperature effective to decrease the viscosity of the amine-functionalised ionic liquid, which may improve the rate at which the amine-functionalised ionic liquid is taken up into the swellable support particles. In some embodiments, the amine-functionalised ionic liquid and swellable support particles is heated to a temperature (in ° C.) of at least about 20, 30, 40, 50, 60, 70, 80, 90, 100, 120, 130, 140 or 150. In some embodiments, the amine-functionalised ionic liquid and swellable support particles is heated to a temperature (in ° C.) of less than about 150, 140, 130, 120, 110, 100, 90, 80, 70, 60, 50, 40, 30 or 20. The temperature may be in a range provided by any two of these upper and/or lower values, for example the amine-functionalised ionic liquid and swellable support particles is heated to a temperature (in ° C.) of between about 20 to 100, 50 to 100 or 60 to 90, e.g. 80. Once the swellable support particles have absorbed sufficient amount of ionic liquid (e.g. as determined by the supports swelling capacity), the particles are cooled which increases the viscosity of the ionic liquid absorbed within the particles.

The amine-functionalised ionic liquid and swellable support particles may be contacted for a period of time effective for the support to absorb and swell with the ionic liquid. In one embodiment, the amine-functionalised ionic liquid and swellable support particles are contacted for a period of time (in minutes) of at least about 5, 10, 15, 20, 25, 30, 35, 40, 45, 50, 55, or 60. In one embodiment, the amine-functionalised ionic liquid and swellable support particles are contacted for a period of time (in minutes) of less than about 60, 55, 50, 45, 40, 35, 30, 25, 20, 15, or 10. The contact time may be in a range provided by any two of these upper and/or lower values, for example the amine-functionalised ionic liquid and swellable support particles are contacted for a period of time (in minutes) of between about 5 to 60.

In some embodiments, the amine-functionalised ionic liquid and swellable support particles are combined in an amount to provide a % w/w ratio of amine-functionalised ionic liquid to swellable support particles of at least about 1:5, 1:4, 1:3, 1:2, 1:1, 1.5:1, 2:1, 2:5:1, 3:1, 3.5:1, 4:1, 4.5:1 or 5:1 based on the total weight of the acidic gas absorbent particulate. In some embodiments, the amine-functionalised ionic liquid and swellable support particles are combined in an amount to provide a % w/w ratio of amine-functionalised ionic liquid to swellable support particles less than about 5:1, 4.5:1, 4:1, 3.5:1, 3:1, 2.5:1, 2:1, 1.5:1, 1:1, 1:2, 1:3, 1:4 or 1:5 based on the total weight of the acidic gas absorbent particulate. The % w/w ratio of amine-functionalised ionic liquid to swellable support particles may be a range provided by any two of these upper and/or lower values, for example the amine-functionalised ionic liquid and swellable support particles are combined in an amount to provide a % w/w ratio of amine-functionalised ionic liquid to swellable support particles of between about 1:1 to 5:1, 1:1 to 3:1 or 1:1 to 2.5:1 based on the total weight of the acidic gas absorbent material. According to some embodiments or examples, a % w/w ratio of amine-functionalised ionic liquid to swellable support particles of between about 1:1 to 3:1 provides one or more advantages, including maximising the amount of reactive amines for capture of the acidic gas (e.g. CO₂ via formation of carbamic acid) present within the swollen support particles whilst maintaining the powdery “dry” characteristics of the support particles, which allows them to flow for example in a fluidised bed reactor.

While the inventors have identified an optimal % w/w ratio of amine-functionalised ionic liquid to swellable support particles to obtain a powdery and dry particulate according to at least some embodiments or examples, in an alternative embodiment, the process further comprises the step of drying the acidic gas absorbent particulate, for example to remove excess ionic liquid and/or residual water left over from the preparation of the amine-functionalised ionic liquid.

Depending on the type of amine-functionalised ionic liquid and/or swellable support particles (such as the type of hydrophilic polymer used to form the hydrogel particles), the swelling conditions and/or amount of each material may be adjusted to promote swelling of the ionic liquid into the support. For example, where a free-flowing acidic gas absorbent particulate is desired, the amount of ionic liquid can be adjusted to obtain a “dry” powdery material whilst retaining maximum loading of the liquid within the support. This can be readily evaluated via visual inspection of the material. Similarly, the materials acidic gas uptake efficiency can be readily determined using a suitable capture apparatus, including that described in the Examples section below.

### Swellable Support Particles

### Cellulose Material Supports

Cellulose material supports may be obtained from a suitable commercial supplier, for example http://www.sawdust.com.au/ass-absorbent-soaking-sawdust.html. Alternatively, the cellulose material may be obtained by shaving, sanding and/or milling a suitable cellulose material, such as a wood or plant product as described herein, to obtain the cellulose material particles. Various chemical spill kits and other cellulose material particulates may also be used as understood by the person skilled in the art. In one embodiment, where the support comprises cellulose material particles, the process may not require any grinding/crushing to obtain the acidic gas absorbent particulate.

### Hydrogel Supports

The process may comprise preparing hydrogel particles. Where the swellable support particles comprise a hydrogel, the process may comprise grinding/crushing/blending the hydrogel to form the hydrogel particles prior to contact with the ionic liquid.

The hydrogel particles may be obtained from a suitable commercial supplier. Alternatively, the process may comprise preparing suitable hydrogel particles.

In some embodiments, the swellable support particles comprise a hydrogel and the process comprises:
mixing a solution comprising a hydrophilic polymer and a cross-linking agent under conditions effective to cross-link the hydrophilic polymer to form the hydrogel;
grinding/crushing the hydrogel to form hydrogel particles; and
contacting the hydrogel particles with the amine-functionalised ionic liquid under conditions effective to absorb the amine-functionalised ionic liquid within the hydrogel particles.

As noted above, the process comprises the step of grinding/crushing the hydrogel to form a plurality of hydrogel particles prior to contacting with the ionic liquid to obtain the acidic gas capture particulate. By increasing the surface area and reducing the hydrogel to particles, effective absorption of the viscous amine-functionalised ionic liquid within the hydrogels is achieved. Any suitable technique can be used to ground the hydrogel, for example using a mortar and pestle, spatula or blender. The hydrogel may have a particle size as described herein.

Where hydrogel particles are used as the swellable support, it will be appreciated that the absorption of the amine-functionalised ionic liquid within the hydrogel may occur ex-situ i.e. after the hydrogel has been formed. Depending on the cross-linker being used to prepare the hydrogel, such ex-situ preparation may avoid any negative interaction between the amine-functionalised ionic liquid and the cross-linker used to form the hydrogel. In an alternative embodiment, the absorption of the amine-functionalised ionic liquid within the hydrogel may occur during the formation of the hydrogel particles i.e. in-situ. For example, the hydrophilic polymer may be cross-linked in the presence of the amine-functionalised ionic liquid to form the hydrogel particles swollen with the ionic liquid.

The hydrophilic polymer and cross-linking agent may be prepared as separate solutions and then mixed in any order to cross-link the hydrophilic polymer to form the hydrogel. Alternatively, the hydrophilic polymer and cross-linking agent may be prepared as a single solution (e.g. both dissolved in the same solution) which is then mixed to cross-link the hydrophilic polymer to form the hydrogel. Provided the hydrophilic polymer and cross-linking agent are mixed in solution, there is no limitation on how the individual components are prepared. The solution used to prepare the hydrogels may be an aqueous solution, such as water. Other suitable solutions may also include alcohols, such as methanol, ethanol, butanol, or isopropanol, which may be easier to remove prior to contact with the amine-functionalised ionic liquid.

The conditions effective to cross-link the hydrophilic polymer to form the hydrogel are described herein. The hydrophilic polymer and cross-linking agent may be mixed at a suitable temperature effective to cross-link the hydrophilic polymer to form the hydrogel. In one embodiment, the hydrophilic polymer and cross-linking agent may be mixed at a temperature of between about 10° C. to about 50° C. to cross-link the hydrophilic polymer to form the hydrogel. The hydrophilic polymer and cross-linking agent may be mixed at a temperature of at least about 10, 12, 15, 17, 20, 22, 25, 28, 30, 35, 40, 45 or 50° C. to cross-link the hydrophilic polymer to form the hydrogel. The hydrophilic polymer and cross-linking agent may be mixed at a temperature of less than about 50, 45, 40, 35, 30, 28, 25, 22, 20, 17, 15, 12 or 10° C. to cross-link the hydrophilic polymer to form the hydrogel. The mixing temperature may be in a range provide by any two of these upper and/or lower values. In some embodiments, the mixing temperature is about about 10, 12, 15, 17, 20, 22, 25, 28, 30, 35, 40, 45 or 50° C. to cross-link the hydrophilic polymer to form the hydrogel.

The hydrophilic polymer and cross-linking agent may be mixed for a period of time effective to cross-link the hydrophilic polymer to form the hydrogel. In one embodiment, the hydrophilic polymer and cross-linking agent are mixed for a period of time of about 5 min to about 60 min to cross-link the hydrophilic polymer to form the hydrogel. In some embodiments, the hydrophilic polymer and cross-linking agent are mixed for a period of time of at least about 5, 10, 15, 20, 25, 30, 35, 40, 45, 50, 55, or 60 min. of about 5 min to about 60 min to cross-link the hydrophilic polymer to form the hydrogel. The hydrophilic polymer and cross-linking agent may be mixed for a period of time of at less than about 60, 55, 50, 45, 40, 35, 30, 25, 20, 15, or 10 min to cross-link the hydrophilic polymer to form the hydrogel. The mixing time may be in a range provide by any two of these upper and/or lower values. In some embodiments, the mixing time is about 5, 10, 15, 20, 25, 30, 35, 40, 45, 50, 55, or 60 min to cross-link the hydrophilic polymer to form the hydrogel.

In some embodiments, one or more other additives may be added to the hydrophilic polymer and cross-linking agent, including for example an initiator and/or catalyst as described herein. For example, where the conditions effective to form the hydrogel comprise free-radical polymerization, it will be appreciated that an initiator (e.g. potassium persulfate) and/or catalyst (e.g. N,N,N′,N′-tetramethyldiaminomethane) can be added to initiate/catalyse the polymerisation and cross-linking of the hydrophilic polymer (e.g. PHEAA hydrogels). Alternatively, in other embodiments, the cross-linking of the hydrophilic polymer does not require the presence of an initiator and/or catalyst (e.g. cross-linked PEI hydrogels).

If required, prior to contacting with the amine-functionalised ionic liquid, the process may further comprise the step of drying the hydrogel to remove excess aqueous solution (e.g. the aqueous solution such as water used to mix the hydrophilic polymer and cross-linking agent). By doing so, this can increase and maximise the amount of ionic liquid that is absorbed within the hydrogel.

### Amine-Functionalised Ionic Liquids

The amine-functionalised ionic liquids may be prepared using conventional techniques, for example by mixing the cation group source with the anion group source in a suitable aqueous solution (e.g. water) under conditions effective to form the ionic liquid. In one example, an amino acid or derivative thereof (e.g. sarcosine) is mixed with a quaternary ammonium base (e.g. tetrabutylammonium hydroxide or choline hydroxide) until the amino acid or derivative thereof has dissolved resulting in the formation of the amine-functionalised ionic liquid. The wt. % amounts of the cation and anion components used to prepare the ionic liquids is understood by the person skilled in the art.

### Methods of Removing Acidic Gas

There is also provided method for removing an acidic gas from a gaseous stream or atmosphere.

In one embodiment, the method comprises contacting the gaseous stream or atmosphere with an acidic gas absorbent, as defined according to any one of the embodiments or examples described herein and/or prepared according to any one of the embodiments or examples described herein, to absorb at least some of the acidic gas from the gaseous stream or atmosphere into the swellable support particles.

Because the particulate is typically a dry, free flowing powder (despite the presence of absorbed amine-functionalised ionic liquid), there is no bulk liquid phase present during the absorption. The gaseous stream or atmosphere may thus be contacted with the particulate in conventional gas-solid contact apparatus, such as a packed bed or fluidized bed of the particles.

The acidic gas absorbents can be used in absorption of acidic gas in a range of industrial processes such as in removing acidic gas from pre-combustion processes such as from hydrocarbon gases, removal of acidic gas from combustion gases, reducing acidic gas produced in manufacture of products, or may be used in reducing the acidic gas content of ambient air. In one embodiment, the gaseous stream or atmosphere is selected from the group consisting of combustion flue gas, a hydrocarbon gas or hydrocarbon gas mixture, emission from cement or steel production, biogas and ambient air.

The acidic gas absorbent particulate composition may be introduced into a gas flowline as a flow of particulate material. The particulate composition can be provided in a packed bed with sufficient interstitial space between adjacent particles to allow a flow of gas therethrough.

The acidic gas absorbent particulate will typically be used to absorb acidic gas by passing a gaseous stream or atmosphere comprising the acidic gas through a housing containing the particulate. The acidic gas is typically absorbed from a gaseous stream or atmosphere at a temperature and can be recovered from the particulate by changing the temperature and/or pressure, particularly by increasing the temperature.

Accordingly, in some embodiments, there is provided a method for capture of an acidic gas from a gaseous stream or atmosphere comprising: providing a chamber enclosing the acidic gas absorbent particulate disclosed herein; passing a flow of the gaseous stream or atmosphere comprising an acidic gas through the chamber and contacting the acidic gas absorbent particulate to absorb at least some of the acidic gas into the absorbed amine-functionalised ionic liquid contained within the hydrogel particles; optionally heating the acidic gas absorbent particulate to a temperature effective to desorb the absorbed acidic gas from the absorbed amine-functionalised ionic liquid contained within the hydrogel particles; and optionally flushing the desorbed acidic gas from the chamber.

The acidic gas may be absorbed into acidic gas absorbent particulate at a wide range of temperatures depending on the specific application and gaseous stream or atmosphere. In one embodiment, the absorption of acidic gas is carried out at a temperature (in ° C.) of less than about 100, 90, 80, 70 or 60, including ranges such as between about 60 to about 100, between about 60 to about 90, between about 60 to about 80, or between 60 to about 70. The acidic gas may be desorbed from the particulate by heating the particles for example using a heated gas stream. In one embodiment, the particles may be heated to a temperature (in ° C.) of at least about 80, 90, 100, 110, 120, 130 or 140, including ranges such as between about 80 to about 110, between about 80 to about 100, between about 80 to about 95, or between about 80 to 90.

The heating of the acidic gas absorbent particulate may be carried out using heated gas such as air, steam or using other heating methods such as thermal radiation or microwave heating. The desorbed acidic gas may be flushed from the housing with a gas such as air, nitrogen or even recycled CO₂.

In one embodiment, the method further comprises a regeneration recovery method to desorb the absorbed acidic gas from the acidic gas absorbent particulate.

### Gaseous Streams, Atmospheres and Acidic Gases

The acidic gas absorbents of the present disclosure can remove an acidic gas from a gaseous mixture containing the acidic gas, including for example a gaseous stream or atmosphere containing the acidic gas.

The “acidic gas” may be carbon dioxide (CO₂) or hydrogen sulfide (H₂S) or a mixture thereof. In one specific embodiment, the acidic gas is CO₂. The acidic gas may be a component of a natural gas, such as acid gas which is understood to be a natural gas mixture that contains significant quantities of acidic gases, namely, H₂S or CO₂. The acid gas may be sour gas, which is a specific type of acid gas that contains a significant amount of H₂S. In one embodiment, the acidic gas may be a contaminant in a hydrocarbon gas. Although the term ‘hydrocarbon gas’ generally refers to natural gas, it will be appreciated by those skilled in the art that the term may equally apply to coal seam gas, associated gas, nonconventional gas, landfill gas, biogas, and flue gas. Alternatively, the acidic gas may be a component of lower acidic gas concentration gaseous streams or atmospheres, such as ambient air.

The acidic gas may be removed from the gaseous stream or atmosphere by being absorbed into the acidic gas absorbent particulate. For example, owing to the amine-functionalised ionic liquid absorbed within the particulate, the acidic gas may be absorbed into the absorbent by both a chemical and physical process. In some embodiments, the swellable particle also comprises functional groups capable of binding to the acidic gas, such as polyamine hydrogel particles.

The gaseous stream or atmosphere may be any stream or atmosphere in which separation of one or more acidic gases from stream or atmosphere is desired. Examples of streams or atmospheres include product gas streams e.g. from coal gasification plants, reformers, precombustion gas streams, post-combustion gas streams (including in-line post combustion gas streams) such as flue gases, the exhaust streams from fossil-fuel burning power plants, sour natural gas, post-combustion, emissions from incinerators, industrial gas streams, exhaust gas from vehicles, exhaust gas from sealed environments such as submarines and the like.

In some embodiments, the gaseous stream or atmosphere may have an acidic gas concentration of less than about 200,000 parts per million (ppm). In one embodiment, the gaseous stream or atmosphere may have an acidic gas concentration of less than 150,000, 100,000, 75,000, 50,000, 25,000, 10,000, 5,000, 4,000, 1,000, 900, 800, 700, 600, 500, 400, 300, 200 or 100 ppm. In another embodiment, the gaseous stream or atmosphere may have an acidic gas concentration of between about 100 ppm to 100,000 ppm, about 100 ppm to about 10,000 ppm, or about 100 ppm to about 5,000 ppm.

It will be understood that 1 ppm equates to 0.0001 vol. %. For example, a gaseous stream or atmosphere having an acidic gas concentration of less than about 100,000 ppm equates to 10.0 vol. % of acidic gas in the gaseous stream.

In some embodiments, the gaseous stream or atmosphere has no flow rate, e.g. 0 m³/hour. In some embodiments, or examples, the gaseous stream has a flow rate of between about 0.01 m³/hr to about 50,000 m³/hr. The flow rate may be at least 0.01, 0.05, 0.1, 0.5, 1, 5, 10, 20, 30, 40, 50, 60, 70, 80, 90, 100, 200, 300, 400, 500, 600, 700, 800, 900 1,000, 2,000, 3,000, 4,000, 5,000, 6,000, 7,000, 8,000, 9,000, 10,000, 15,000, 17,000, 20,000, 30,000, 40,000, or 50,000 cubic metres per hour (m³/hr). In some embodiments, the gaseous stream has a flow rate of less than 50,000, 40,000, 30,000, 20,000, 17,000, 15,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 5, 1, 0.5, 0.1, 0.05, or 0.01 m³/hr. Combinations of these flow rates are also possible, for example between about 0.01 m³/hour to about 1500 m³/hour, between about 5 m³/hour to about 1000 m³/hour, between about 10 m³/hour to about 500 m³/hour, between about 20 m³/hour to about 200 m³/hour, between about 60 m³/hour to about 1000 m³/hour, between about 0.01 m³/hr to about 5,000 m³/hr, about 5,000 to about 40,000 m³/hr, about 7,000 m³/hr to about 30,000 m³/hr, or about 10,000 m³/hr to about 20,000 m³/hour.

In some embodiments, increasing the flow rate of the gaseous stream or atmosphere as it contacts the acidic gas absorbent particulate leads to a faster rate of CO₂ absorption and capture in the acidic gas absorbent particulate. For industrial scale applications, the flow rate of the gaseous stream may be up to 1000 m³/hour. In some embodiments, the gaseous stream has no flow rate (e.g. an ambient atmosphere).

### Low CO₂ Concentration Gaseous Streams or Atmospheres

In one embodiment, the gaseous stream or atmosphere is a low CO₂ concentration gaseous stream or atmosphere. In one embodiment, the low CO₂ concentration gaseous stream or atmosphere is ambient air.

The acidic gas absorbent particulate of the present disclosure can remove CO₂ from low CO₂ concentration gaseous streams or atmospheres. For example, the process can remove CO₂ from a low CO₂ concentration gaseous stream or atmosphere. Examples of low concentration gaseous streams or atmospheres include the atmosphere (e.g. ambient air), ventilated air (e.g. air conditioning units and building ventilation), and partly closed systems which recycle breathing air (e.g. submarines or rebreathers). In some embodiments, the low CO₂ concentration gaseous stream or atmosphere may have a CO₂ concentration of less than about 200,000 parts per million (ppm). In one embodiment, the low CO₂ concentration gaseous stream or atmosphere may have a CO₂ concentration of less than 150,000, 100,000, 75,000, 50,000, 25,000, 10,000, 5,000, 4,000, 1,000, 900, 800, 700, 600, 500, 400, 300, 200 or 100 ppm. In another embodiment, the low CO₂ concentration gaseous stream or atmosphere may have a CO₂ concentration of between about 100 ppm to 100,000 ppm, about 100 ppm to about 10,000 ppm, about 100 ppm to about 5,000 ppm, about 100 ppm to about 1,000 ppm or about 100 ppm to about 500 ppm. In one embodiment, the low CO₂ concentration gaseous stream or atmosphere may have a CO₂ concentration of between about 200 ppm to about 500 pm, such as about 400 to 450 ppm.

In some embodiments, the low CO₂ concentration gaseous stream or atmosphere may have a CO₂ concentration of less than about 20, 15, 10, 7.5, 5, 2.5, 1, 0.5, 0.1, 0.09, 0.08, 0.07, 0.06, 0.05, 0.04, 0.03, 0.02 or 0.01 vol. %. In another embodiment, the low CO₂ concentration gaseous stream or atmosphere may have a CO₂ concentration of between about 0.01 vol. % to about 10 vol. %, about 0.01 vol. % to about 1 vol. %, about 0.01 vol. % to about 0.1 vol. %, or 0.01 vol. % to about 0.05 vol. %. In one embodiment, the low CO₂ concentration gaseous stream or atmosphere may have a CO₂ concentration of between about 0.02 vol. % to about 0.05 vol. %, such as about 0.04 vol. %.

In one embodiment, the low CO₂ concentration gaseous stream or atmosphere may have a CO₂ concentration the same as in ambient air (e.g. the atmosphere). Thus in one embodiment, the low CO₂ concentration gaseous stream or atmosphere may have a CO₂ concentration of about 400 ppm to 450 ppm CO₂, for example about 400 ppm to 415 ppm as in ambient air in most locations around the world. Accordingly, in one embodiment, the process is for direct air capture (DAC).

In one embodiment or example, the process is for direct air capture in indoor sealed environments (DACi). Thus, the CO₂ concentration gaseous stream or atmosphere may have a CO₂ concentration of up to 2,000 ppm. In one embodiment or example, the process is for direct air capture in external power plants (DACex). Thus, the CO₂ concentration gaseous stream or atmosphere may have a CO₂ concentration of about 3,000 ppm to about 150,000 ppm.

In one embodiment or example, the gaseous stream or atmosphere may comprise less than 100 ppm (i.e. 0.01 vol. %) hydrocarbon gas. In one embodiment, the gaseous stream or atmosphere may comprise less 10, 8, 5, 2, 1, 0.5, 0.1 or 0.01 vol. % hydrocarbon gas. In one embodiment, the gaseous stream or atmosphere may comprise less than 100 ppm (i.e. 0.01 vol. %) hydrocarbon gas. For example, the gaseous stream or atmosphere may comprise less than about 100, 75, 50, 25, 20, 15, 10, 5, 4, 3, or 2 ppm hydrocarbon gas. The term ‘hydrocarbon gas’ will be understood to refer to a gaseous mixture of hydrocarbon compounds including, but not limited to methane, ethane, ethylene, propane, and other C3+ hydrocarbons. For example, it will be understood by a person skilled in the art that ambient air comprises methane as a minor impurity (e.g. 2 ppm/0.0002 vol. %), and that ambient air therefore may comprise less than 3 ppm hydrocarbon gas. The low CO₂ concentration gaseous stream or atmosphere may comprise predominantly of nitrogen makes up the major vol. % proportion in the gaseous stream. For example, the low CO₂ concentration gaseous stream or atmosphere may comprise at least about 50 vol. % nitrogen, for example at least about 70 vol. % nitrogen. In one embodiment, the low CO₂ concentration gaseous stream comprises about 78 vol. % nitrogen (e.g. ambient air).

The low CO₂ concentration gaseous stream or atmosphere may comprise an amount of water (e.g. the gaseous stream is damp/moist for example a humid gaseous stream). For example, the low CO₂ concentration gaseous stream or atmosphere may comprise between about 1 vol. % to about 10 vol. % water. Alternatively, the low CO₂ concentration gaseous stream or atmosphere may be a dry gaseous stream.

In some embodiments, the gaseous stream or atmosphere originates from a ventilation system, for example building ventilation or air conditioning. In other embodiments, the gaseous stream or atmosphere originates from a closed, or at least partially closed system, designed to recycle breathing gas, for example in a submarine, space craft, or aircraft. It will be appreciated that the acidic gas absorbent particulates of the present disclosure can also absorb CO₂ from gaseous streams or atmospheres with higher CO₂ concentrations, highlighting the versatility of the acidic gas absorbent particulates for a wide range of air capture applications. In an example, it is the ability of the acidic gas absorbent particulates to capture CO₂ at relatively low concentrations (e.g. 400 ppm) which the present inventors found particularly surprising.

The low CO₂ concentration gaseous stream or atmosphere is contacted with the acidic gas absorbent particulate. The gaseous stream or atmosphere may have a suitable flow rate to contact (e.g. pass through) the acidic gas absorbent particulate. Alternatively, the gaseous stream or atmosphere may come into contact with the acidic gas absorbent particulate without any back pressure or flow rate being applied (e.g. the gaseous stream may organically diffuse into the acidic gas absorbent particulate upon contact). In some embodiments, the gaseous stream or atmosphere may be an atmosphere surrounding the acidic gas absorbent particulate, for example a low CO₂ concentration atmosphere. In some embodiments, the gaseous stream or atmosphere passes through the acidic gas absorbent particulate (e.g. enters from a first side or face on the acidic gas absorbent particulate and exits from different side or face) or it may simply diffuse into the acidic gas absorbent particulate, for example when the acidic gas absorbent particulate is placed in an atmosphere, such as ambient air. As such, it will be understood that in some embodiments the gaseous stream does not need to be applied with a back pressure to essentially force the gaseous stream “through” the acidic gas absorbent particulate, although in some embodiments this may be desirable, such as when the acidic gas absorbent particulate is configured to a building ventilation system, for example. In one embodiment, the gaseous stream (e.g. atmosphere) diffuses into the acidic gas absorbent particulate upon contact with the acidic gas absorbent particulate.

The concentration of CO₂ in the gaseous stream or atmosphere can be measured by any suitable means, for example an isotopic analyser (e.g. using a G2201-i Isotopic Analyzer (PICARRO) and/or infrared spectrometer (e.g. an in-line calibrated cavity ring-down IR spectrometer). The concentration of CO₂ in the gaseous stream or atmosphere can be monitored by any suitable means, for example an SprintIR®-6S covering a range from 0-100% and K30 ambient sensor with a range of 0-1% CO₂.

### Methods for Acidic Gas Capture/Release and Regeneration of Acidic Gas Absorbent Particulate

There is also provided method for removing an acidic gas from a gaseous stream or atmosphere. The acidic gas (e.g. CO₂) may be removed from the gaseous stream or atmosphere by being absorbed into an acidic gas absorbent particulate.

In one embodiment, the method comprises contacting the gaseous stream or atmosphere with the acidic gas absorbent particulate to absorb at least some of the acidic gas from the gaseous stream or atmosphere into the absorbed amine-functionalised ionic liquid contained within the hydrogel particles.

In some embodiments, the acidic gas absorbent particulate is capable of absorbing between about 10 mg of acidic gas per g of acidic gas absorbent particulate (mg/g) to about 300 mg/g acidic gas. In some embodiments, the acidic gas absorbent particulate is capable of absorbing at least about 10, 20, 30, 40, 50, 60, 70, 80, 90, 100, 120, 150, 200, 250 or 300 mg/g acidic gas. In other embodiments, the acidic gas absorbent particulate is capable of absorbing less than about 300, 250, 200, 150, 120, 100, 90, 80, 70, 60, 50, 40, 30, 20 or 10 mg/g acidic gas. Combinations of these absorption values are possible, for example the acidic gas absorbent particulate is capable of absorbing between about 10 mg/g to about 80 mg/g acidic gas, between about 20 mg/g to about 70 mg/g acidic gas, or between about 100 mg/g to about 300 mg/g, or between about 200 mg/g to about 300 mg/g.

In some embodiments, the acidic gas absorbent particulate is capable of absorbing between about 1% to about 20% wt. acidic gas. In some embodiments, the acidic gas absorbent particulate is capable of absorbing at least about 1, 2, 3, 4, 5, 7, 10, 12, 14, 16, 18 or 20% wt. acidic gas. In some embodiments, the acidic gas absorbent particulate is capable of absorbing less than about 20, 18, 16, 14, 12, 10, 7, 5, 4, 3, 2 or 1% wt. acidic gas. Combinations of these absorption values are possible, for example between about 1% to 10% wt. acidic gas.

In some embodiments, at least about 10% of acidic gas is removed from the gaseous stream or atmosphere (e.g. at least about 10% of CO₂ is absorbed into the acidic gas absorbent particulate from the gaseous stream or atmosphere). In some embodiments, at least about 10%, 25%, 50%, 75%, 90%, or 95% of acidic gas is removed from the gaseous stream or atmosphere.

The gaseous stream or atmosphere contacts the acidic gas absorbent particulate (e.g. passes through a bed comprising the acidic gas absorbent particulate) resulting in an effluent gaseous stream following contact with the acidic gas absorbent particulate. As described above, before contact with the acidic gas absorbent particulate, the gaseous stream has an initial acidic gas concentration. After contact with the acidic gas absorbent particulate, the effluent gaseous stream has an effluent acidic gas concentration. The concentration of acidic gas in the effluent gaseous stream following contact with the acidic gas absorbent particulate may be measured to determine the concentration of acidic gas remaining in the gaseous stream. In one embodiment, the process further comprises measuring the concentration of acidic gas in an effluent gaseous stream or atmosphere following contact with the acidic gas absorbent particulate.

In some embodiments, over time, the concentration of acidic gas in the effluent gaseous stream following contact with the acidic gas absorbent particulate may increase indicating reduced or no more acidic gas absorption is taking placed upon contact of the gaseous stream with the acidic gas absorbent particulate (e.g. indicating the acidic gas absorbent particulate is “saturated” (e.g. spent) and little to no more acidic gas absorption is occurring). This can act as an indicator to replace and/or regenerate the acidic gas absorbent particulate to continue acidic gas capture. The concentration of acidic gas in the effluent gaseous stream may be measured by any suitable means, for example using an in-line calibrated cavity ring-down IR spectrometer.

In some embodiments, the acidic gas absorbent particulate may be enclosed in a suitable chamber, wherein the chamber comprises one or more inlets through which the gaseous stream can flow to contact the acidic gas absorbent particulate enclosed therein, and one or more outlets through which the effluent stream can flow out from the chamber. Alternatively, the acidic gas absorbent particulate may be enclosed in a suitable chamber comprising one or more openings through which the gaseous stream can diffuse through to contact the acidic gas absorbent particulate enclosed therein. It will be appreciated that the chamber can take a number of forms provided the gaseous stream can access the acidic gas absorbent particulate. In one embodiment, the chamber may be a packed-bed column as described herein.

In some embodiments, the acidic gas absorbent particulate may be provided as a bed, wherein the contacting the gaseous stream with the acidic gas absorbent particulate comprises passing the gaseous stream through the bed comprising the acidic gas absorbent particulate. In one embodiment, the acidic gas absorbent particulate is provided as a packed-bed reactor. In other embodiments, the contacting the gaseous stream with the acidic gas absorbent particulate comprises introducing a flow of the acidic gas absorbent particulate into the gaseous stream or atmosphere, for example using a fluidised bed reactor. Surprisingly and according to some embodiments or examples, an acidic gas absorbent particulate comprising viscous, “sticky” ionic liquids is still cable of flowing and retained dry and powdery characteristics.

The acidic gas absorbent particulate may be contacted with the gaseous stream for any suitable period of time, for example until the acidic gas absorbent particulate is spent and no more acidic gas absorption is occurring. In one embodiment, the acidic gas absorbent particulate is in contact with the gaseous stream until the concentration of acidic gas in the effluent gaseous stream is the same as the initial concentration of acidic gas of the gaseous stream. In some embodiments, the acidic gas absorbent particulate is in contact with the gases stream for at least about 5, 10, 30, 60 seconds (1 minute), 10, 15, 20, 30, 45, 60 minutes (1 hour), 2, 5, 10, 24, 48 or 36 hours.

In some embodiments, the acidic gas absorbent particulate provides various rates of acidic gas absorption. In one embodiment, the rate of acidic gas absorption can be measured by monitoring the acidic gas concentration of the effluent gaseous stream over time. For example, the concentration of acidic gas in the effluent gaseous stream may be less than about 50% of the initial acidic gas concentration after about 20 minutes of contact with the acidic gas absorbent particulate. In some examples, the concentration of acidic gas in the effluent gaseous stream may be less than about 5% of the initial acidic gas concentration after about 100 seconds of contact with the acidic gas absorbent particulate (in other words at least about 95% of acidic gas is removed from the gaseous stream after 100 seconds). Other rates of acidic gas absorption are also possible.

The acidic gas after absorption in the acidic gas absorbent particulate can be released by breaking the bonds between the acidic gas and the amine groups of the amine-functionalised ionic liquid (e.g. the bond between the CO₂ and amine). This can be achieved through using temperature (through heating) or pressure (through vacuum). This may involve heating the column containing the acidic gas absorbent particulate or passing through a hot gas stream (e.g. steam) or hot air. Such desorption may be provided by any suitable environment capable of providing a heated environment (e.g. temperature) or a pressurised environment (e.g. through vacuum), or a combination thereof, in contact with or surrounding the acidic gas absorbent particulate which can desorb at least some of the acidic gas absorbed within the acidic gas absorbent particulate. Such desorption environment can operate in an “on” or “off” state. For example, once the concentration of acidic gas in the effluent gaseous stream following contact with the acidic gas absorbent particulate has increased to a level indicating reduced or no more acidic gas absorption is taking place, the desorption environment may be switched “on” to desorb acidic gas from the acidic gas absorbent particulate.

In some embodiments, at least 70%, 80%, 85%, 90%, 95%, 97%, 98% or 99% of the absorbed acidic gas is desorbed from the acidic gas absorbent particulate.

### Acidic Gas Removal Apparatus

FIG. 5 depicts an apparatus 500 for performing the method for capture of an acidic gas from a gaseous stream or atmosphere, according to some embodiments or examples. Apparatus 500 includes first column 510 comprising chamber 511, gas inlet 512 and gas outlet 514, and second column 520 comprising chamber 521, gas inlet 522 and gas outlet 524. The chamber of each column is loaded with the acidic gas absorbent particulate 530, for example as a packed bed or fluidized bed. The acidic gas absorbent particulate 530 is a dry, free flowing powder of particles comprising an acid gas absorbent and amine-functionalised ionic liquid as disclosed herein. Columns 510 and 520 are configured to be fed through their respective gas inlets with either gaseous stream or atmosphere 540 or flush gas 542 via gas manifolds 544 and 546. The gas effluent exiting the columns via their respective gas outlets are directed to either transfer line 560, for acidic gas lean gas, or transfer line 562, for acidic gas enriched gas, via gas manifolds 564 and 566.

In use, gaseous stream or atmosphere 540 is directed via manifolds 544, 546 to column 510 where it flows through chamber 511 and contacts the acidic gas absorbent particulate 530 therein. Gaseous stream or atmosphere 540 may, for example, contain CO₂ as the acidic gas to be captured. The acidic gas is absorbed into acidic gas absorbent particulate. The gas effluent leaving column 510 is thus depleted of at least a portion of the acidic gas, and is directed by gas manifolds 564, 566 to transfer line 560 which sends the acidic gas lean gas (treated gaseous stream or atmosphere 540) for further processing or atmospheric release.

After a period of time, the absorption capacity of acidic gas absorbent particulate 530 in column 510 will approach its maximum and the material must be regenerated to avoid unacceptable breakthrough of the acidic gas. Therefore, gaseous stream or atmosphere 540 is redirected via manifolds 544, 546 to column 520 where it flows through chamber 521 and contacts acidic gas absorbent particulate 530 therein. The gas effluent leaving column 520 is thus depleted of at least a portion of the acidic gas, and is directed by gas manifolds 564, 566 to transfer line 560.

While gaseous stream or atmosphere 540 is being processed in column 520, the composition 530 in column 510 is regenerated by heating the acidic gas absorbent particulate to a temperature sufficient to desorb the acidic gas from the particles. The desorbed acidic gas is then flushed from chamber 511 of column 510 with flush gas 542. The acidic gas absorbent particulate may be heated with flush gas 552, which is fed for contact with the composition at a suitably high temperature and/or by other conventional means of heating the particulate in a column. The gas effluent leaving column 510 is thus rich in acidic gas, and is directed by gas manifolds 564, 566 to transfer line 562 which sends the acidic gas enriched gas for storage or further processing. By switching the columns sequentially between absorption and desorption modes in this manner, acid gas 540 can be continuously processed to capture all or part of the acidic gas therefrom.

Accordingly, there is provided an acidic gas removal apparatus comprising a chamber enclosing an acidic gas absorbent particulate as defined according to any one of the embodiments or examples described herein and/or prepared according to any one of the embodiments or examples described herein, wherein the chamber brings the gaseous stream or atmosphere into contact with the acidic gas absorbent particulate to absorb at least some of the acidic gas into the absorbed amine-functionalised ionic liquid contained within the swellable support particles.

In one embodiment, the swellable support particles are hydrogel particles, and the chamber brings the gaseous stream or atmosphere into contact with the hydrogel particles to absorb at least some of the acidic gas into the absorbed amine-functionalised ionic liquid contained within the hydrogel particles

In one embodiment, the chamber of the acidic gas removal apparatus may comprise a packed bed or fluidized bed of the swellable support particles (e.g. hydrogel particles).

In one embodiment, the chamber comprises an inlet through which gaseous stream or atmosphere can flow to the acidic gas absorbent and an outlet through which an effluent gaseous stream or atmosphere can flow out from the acidic gas absorbent particulate. The acidic gas absorbent particulate may be located between the inlet and outlet of the chamber. In one embodiment, the swellable support particles are hydrogel particles and the chamber comprises an inlet through which gaseous stream or atmosphere can flow to the hydrogel particles and an outlet through which an effluent gaseous stream or atmosphere can flow out from the hydrogel particles.

In some embodiments or examples, the apparatus may comprise two or more chambers enclosing the acidic gas absorbent particulate in each chamber connected in parallel to the gaseous stream. The apparatus may comprise at least three chambers enclosing the acidic gas absorbent particulate in each chamber, wherein each chamber may be connected in parallel to the gaseous stream. The acidic gas absorbent particulate enclosed within the at least three chambers may be operated in different sections of the absorption and regeneration cycle to produce a continuous flow of the effluent gaseous stream.

Fluid flow is typically required to move the gaseous stream from the inlet of the chamber, across the acidic gas absorbent particulate enclosed and out of the chamber through the outlet. The fluid flow may be driven by at least one fluid flow device which drives a fluid flow from the inlet to the outlet of the acidic gas removal apparatus. A variety of different fluid flow devices can be used. In some embodiments or examples, the fluid flow device comprises at least one fan or pump. In some embodiments, or examples, the flow rate of the gaseous stream entering through the inlet, across the acidic gas absorbent particulate, may be between about 0.01 m³/hr to about 50,000 m³/hr. The flow rate may be at least 0.01, 0.05, 0.1, 0.5, 1, 5, 10, 20, 30, 40, 50, 60, 70, 80, 90, 100, 200, 300, 400, 500, 600, 700, 800, 900 1,000, 2,000, 3,000, 4,000, 5,000, 6,000, 7,000, 8,000, 9,000, 10,000, 15,000, 17,000, 20,000, 30,000, 40,000, or 50,000 cubic metres per hour (m³/hr). In some embodiments, the gaseous stream has a flow rate of less than 50,000, 40,000, 30,000, 20,000, 17,000, 15,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 5, 1, 0.5, 0.1, 0.05, or 0.01 m³/hr. Combinations of these flow rates are also possible, for example between about 0.01 m³/hr to about 5,000 m³/hr, about 5,000 to about 40,000 m³/hr, about 7,000 m³/hr to about 30,000 m³/hr, or about 10,000 m³/hr to about 20,000 m³/hour. The flow rate of the gaseous stream through the chamber and across the acidic gas absorbent particulate may be achieved with substantially no back pressure measurable through or across the acidic gas absorbent particulate. In an alternate embodiment or example, pressure variance or suction may be used to drive fluid flow of the gaseous stream through the device. For industrial scale applications, the flow rate of the gaseous stream may be up to 1000 m³/hour.

The chamber may have any suitable configuration. In some embodiments or examples, the chamber comprises an inlet at one end and an outlet at the opposite end. In an embodiment or example, a substrate, as described herein, can be located or otherwise packed within the chamber in a compacted manner to increase the surface area within that volume.

The apparatus may comprise a single or multiple chambers, wherein each chamber may enclose the acidic gas absorbent particulate, as described herein. In some embodiments or examples, the apparatus may comprise two or more chambers enclosing a acidic gas absorbent particulate in each chamber connected in parallel to the gaseous stream. In another embodiment or example, the apparatus may comprise at least three chambers enclosing the acidic gas absorbent particulate in each chamber, wherein each chamber may be connected in parallel to the gaseous stream. In some embodiments or examples, the acidic gas absorbent particulate enclosed within the at least three chambers may be operated in different sections of the absorption and regeneration cycle to produce a continuous flow of the effluent gaseous stream.

In some embodiments or examples, the method may be a cyclical method, where the steps of adsorbing the acidic gas in the acidic gas absorbent particulate enclosed by the chamber and releasing the acidic gas through operation of at least one desorption arrangement in a repetitive cycle so to continuously produce the effluent gaseous stream. The cycle time may depend on configuration of the acidic gas removal apparatus, the configuration of the chamber(s), the type of desorption arrangement, the composition of the acidic gas absorbent particulate, breakthrough point, saturation point and characteristics of the acidic gas absorbent particulate, temperature, pressure and other process conditions. In some embodiments or examples, the cycle time may be about 10, 15, 20, 30, 45, 60 minutes (1 hour), 2, 5, 10, 24, 48 or 36 hours.

In some embodiments or examples, the desorption arrangement can take any number of forms depending on whether heat and/or reduced pressure is being used. In some embodiments or examples, the apparatus is designed for pressure swing absorption, with desorption being achieved by reducing the pressure for example using a vacuum pump to evacuate the gas from around the chamber enclosing the acidic gas absorbent particulate. In other embodiments or examples, temperature swing absorption is undertaken to collect the acidic gas from the acidic gas absorbent particulate. This can be achieved using direct heating methods.

In some embodiments or examples, the desorption arrangement may comprise a temperature swing absorption arrangement where the acidic gas absorbent particulate is heated. For example, operating at least one desorption arrangement heats the acidic gas absorbent particulate to a temperature of between about 20 to 140° C.

The present disclosure provides a method where a gaseous stream containing a concentration of acidic gas is fed into adsorptive contact with the acidic gas absorbent particulate, as described herein. After the acidic gas absorbent particulate is charged with an amount of the acidic gas, the desorption arrangement is activated forcing at least a portion of the acidic gas to be released from the acidic gas absorbent particulate. The desorbed acidic gas absorbent particulate can be collected using a secondary process.

In other words, the effluent gaseous stream from the outlet can flow to a variety of secondary processes. For example, for carbon dioxide capture, the acidic gas removal apparatus of the present disclosure can be integrated with a liquefier and/or dry ice pelletiser to provide dry ice on-demand. In another example, the acidic gas removal apparatus of the present disclosure can be integrated with a hydrogenation apparatus to convert carbon dioxide (CO₂) to methane. In yet another example, the acidic gas removal apparatus of the present disclosure may be used to adsorb carbon dioxide (CO₂) and store it for use at a different time. This would be applicable in a green-house type environment where CO₂ is adsorbed at a particular time and used at a different time. In yet another example, the acidic gas removal apparatus of the present disclosure may be particularly applicable for CO₂ in a confined space. For example, inside a submarine, space craft, air craft or other confined space like a room where the acidic gas removal apparatus would be used to remove CO₂, and the apparatus capable of adsorbing and desorbing CO₂ in a continuous cycle.

The acidic gas removal apparatus of the present disclosure is advantageously compact and can be located much closer to end users, thereby allowing disruptive supply opportunities and better customer value.

The present application claims priority from AU2022901111 filed on 28 Apr. 2022, the entire contents of which are incorporated herein by reference.

### EXAMPLES

In order that the disclosure may be more clearly understood, particular embodiments of the invention are described in further detail below by reference to the following non-limiting experimental materials, methodologies and examples.

### General Materials

All chemicals are purchased from commercial sources and are used as supplied. Ambient air was used for the direct air capture studies.

### Example 1: Fabrication of Hydrogel Particles for Use as the Swellable Support

The concentration of monomer/cross-linker and the ratio of monomer to cross-linker were varied to develop a material that had satisfactory swelling characteristics for the amine-functionalised ionic liquid as well as providing a powdery “dry” material that had good permeability required for direct air capture at high flow rates.

For cross-linked polyacrylamide hydrogel particles, 360 grams of acrylamide and 90 grams of N—N′-methylenebis(acrylamide) were dissolved in 1500 mL of distilled water with vigorous stirring at room temperature.

For cross-linked PHEAA hydrogel particles, 600 grams of N-2-hydroxyethyl(acrylamide) and 120 grams of N—N′-methylenebis(acrylamide) were dissolved in 1500 mL of distilled water with vigorous stirring at room temperature.

For the cross-linked polyacrylamide and PHEAA hydrogel particles, the solutions were stirred vigorously while bubbling a high flow rate of N₂ for at least 20 minutes until the solids in both solutions dissolved.

For both the cross-linked polyacrylamide and PHEAA hydrogels, while maintaining a high flow rate of N₂ and vigorous stirring, 1 mL of N,N,N′,N′-tetramethyldiaminomethane was added and then 1 gram of potassium persulfate was added to initiate the cross-linking and polymerization. Once cross-linking was complete, the N₂ stream was removed and the mixture was placed in an oven at 80° C. for 12 hours to dry the hydrogel, and then a spatula/powder grinder (a food blender was used in this case) was used to create a fine hydrogel particulate.

For the polyethylenimine hydrogel particles (“PEI Snow”), an aqueous solution comprising 30 wt. % PEI (Mw 25,000) and 2 wt. % BDDE cross-linker was mixed to initiate the PEI crosslinking at ambient temperature to form a bulk PEI gel. The bulk PEI gel was vigorously ground using a glass stirring rod to obtain a snow-like material that had an average particle size of 300 μm.

The hydrogel particles were then placed in the oven for a further 48 hours to remove essentially all the water, and was then subjected to further grinding and sieving through a 425-micron metal sieve to obtain the hydrogel particles

### Example 2: Fabrication of Amine-Functionalised Ionic Liquids

For the synthesis of the amino acid ionic liquids, an equimolar amount of sarcosine (131776) and either a 40 wt. % tetrabutylammonium hydroxide in water (Aldrich, 178780) or a 46 wt. % choline hydroxide in water (Aldrich, 292257) was combined with vigorous stirring until the sarcosine dissolved resulting in tetrabutylammonium sarcosinate (TSA) and choline sarcosinate (CSA). The water was then removed at 80° C. in a vacuum oven with P₂O₅ desiccant for 48 hours.

### Example 3: Swelling of Hydrogel Particles with Amine-Functionalised Ionic Liquid

The hydrogel particles prepared in Example 1 and the amine-functionalised ionic liquid prepared in Example 2 were simply combined, typically in a 1:1 to 2:1 mass ratio (ionic liquid:hydrogel). The ratio is chosen to maximize the amount of ionic liquid present while maintaining a material that has a powdery characteristic. Depending on the viscosity of the ionic liquid, the sample is heated in an oven (to approximately 80° C.) to decrease the viscosity of the ionic liquid making it easier for the sorbent to swell the ionic liquid.

### Example 4: Swelling of Wood Flour Particles with Amine-Functionalised Ionic Liquid

Tetrabutylammonium sarcosinate (TSA) prepared in Example 2 was combined with saw dust in a 1.5:1 ionic liquid to saw dust ratio, resulting in the saw dust swelling and absorbing TSA to form a flowable “dry” powder. FIG. 2 is a photo of the resultant material.

### Example 5: Amine-Functionalised Ionic Liquid Acidic Gas Absorbents Effectively Capture CO₂

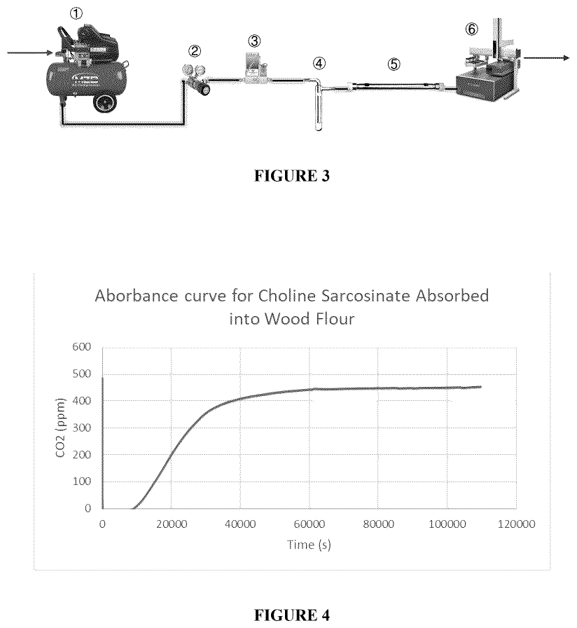

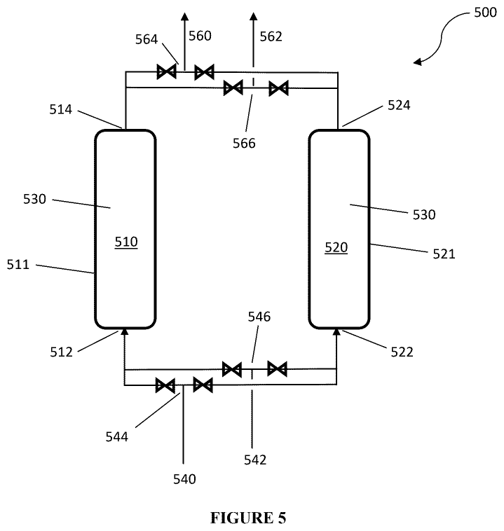

The tetrabutylammonium sarcosinate (TSA) swollen saw dust was packed into a column (see FIG. 3) where air is flowed through the column. Upon contact of the material with a gas stream of air, the inlet and outlet column concentrations of CO₂ can be measured using an flow-through NDIR CO₂ sensor which shows that outlet CO₂ is substantially reduced indicating efficient removal of CO₂ from the gas stream (see FIG. 4).

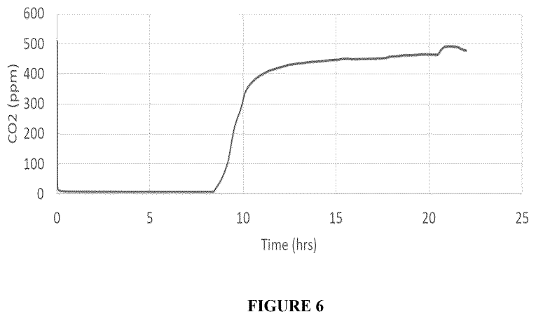

Similarly, the TSA swollen PEI hydrogel particles was packed into the column as outlined above to measure CO₂ uptake. Outlet CO₂ substantially reduced indicating efficient removal of CO₂ from the gas stream (see FIG. 6). Total CO₂ uptake by the TSA swollen PEI hydrogel particles was 5.5% CO₂ on a mass basis.

### Example 6: CO₂ Capture into Alternative Porous Supports Loaded with Ionic Liquids (Comparative)

An attempt was made to load Tetrabutylammonium sarcosinate (TSA) into an activated carbon (AC) porous support. TSA was mixed with activated carbon at a ratio of 1:1.5 (AC:TSA). Unlike for hydrogels, any liquid loading of AC relies on filling the pore space and not swelling the support. While ionic liquid uptake into the pores of AC was observed, when air was flown therethrough using the as per Example 5, the CO₂ uptake into the TSA within the AC was <1%, because the TSA within the pores had low contact with the gas. A similar lower uptake was also observed when using silica supports.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. An acidic gas absorbent particulate for capture of an acidic gas from a gaseous stream or atmosphere, wherein the acidic gas absorbent particulate comprises hydrogel particles, and wherein the hydrogel particles contain absorbed amine-functionalised ionic liquid for absorbing the acidic gas.

2. The acidic gas absorbent particulate of claim 1, wherein:
a) the hydrogel particles comprise between about 5% w/w to about 95% w/w of amine-functionalised ionic liquid based on the total weight of the acidic gas absorbent particulate; and/or
b) wherein the % w/w ratio of amine-functionalised ionic liquid to hydrogel particles in the acidic gas absorbent particulate is between about 1:1 to about 5:1 based on the total weight of the acidic gas absorbent particulate.

3. (canceled)

4. The acidic gas absorbent particulate of claim 1, wherein the amine-functionalised ionic liquid comprises an anion group and a cation group, wherein the anion group is an amino acid or derivative thereof.

5. The acidic gas absorbent particulate of claim 4, wherein the amino acid or derivative thereof comprises at least one amine functional group and at least one functional group selected from a carboxylic acid, sulfonic acid, and phosphonic acid.

6. (canceled)

7. The acidic gas absorbent particulate of claim 4, wherein the amino acid or derivative thereof is selected from the group consisting of glycine, sarcosine, isopropylglycine, and taurine.

8. The acidic gas absorbent particulate of claim 4, wherein the cation group is an onium cation group selected from an ammonium cation groups, phosphonium cation groups, pyridinium cation groups, imidazolium cation groups, pyrazolium cation groups, and pyrrolidinium cation groups.

9. (canceled)

10. The acidic gas absorbent particulate of claim 1, wherein the hydrogel particles have a mean average particle size of between about 10 μm to about 500 μm.

11. The acidic gas absorbent particulate of claim 1, wherein the acidic gas absorbent particulate is in the form of a free-flowing powder.

12. The acidic gas absorbent particulate of claim 1, wherein the hydrogel comprises a cross-linked polyamine.

13. (canceled)

14. The acidic gas absorbent particulate of claim 12, wherein the polyamine is a polyalkylenimine.

15. The acidic gas absorbent particulate of claim 14, wherein the polyalkylenimine is selected from the group consisting of polyethylenimine, polypropylenimine, and polyallylamine, or a copolymer thereof.

16-18. (canceled)

19. A process for preparing the acidic gas absorbent particulate of claim 1, comprising contacting an amine-functionalised ionic liquid with hydrogel particles under conditions effective to absorb the amine-functionalised ionic liquid within the hydrogel particles.

20-22. (canceled)

23. A method for removing an acidic gas from a gaseous stream or atmosphere, comprising contacting the gaseous stream or atmosphere with the acidic gas absorbent particulate of claim 1 to absorb at least some of the acidic gas from the gaseous stream or atmosphere into the absorbed amine-functionalised ionic liquid contained within the hydrogel particles.

24. The method of claim 23, wherein the acidic gas is carbon dioxide (CO₂) or hydrogen sulphide (H₂S), or a combination thereof.

25. The method of claim 23, wherein the gaseous stream or atmosphere is selected from the group consisting of combustion flue gas, a hydrocarbon gas or hydrocarbon gas mixture, emission from cement or steel production, biogas and ambient air.

26. The method of claim 23, wherein the contacting the gaseous stream or atmosphere with the acidic gas absorbent particulate comprises
a) passing the gaseous stream or atmosphere through a bed comprising the acidic gas absorbent particulate; or
b) introducing a flow of the acidic gas absorbent particulate into the gaseous stream or atmosphere.

27. (canceled)

28. The method of claim 23, wherein the method further comprises a regeneration recovery method to desorb the absorbed acidic gas from the acidic gas absorbent particulate.

29. The method of claim 23, the method comprising:
providing a chamber enclosing the acidic gas absorbent particulate;
passing a flow of the gaseous stream or atmosphere comprising an acidic gas through the chamber and contacting the acidic gas absorbent particulate to absorb at least some of the acidic gas into the absorbed amine-functionalised ionic liquid contained within the hydrogel particles;
optionally heating the acidic gas absorbent particulate to a temperature effective to desorb the absorbed acidic gas from the absorbed amine-functionalised ionic liquid contained within the hydrogel particles; and
optionally flushing the desorbed acidic gas from the chamber.

30. An acidic gas removal apparatus for capturing acidic gas comprising a chamber enclosing an acidic gas absorbent particulate for capture of acidic gas from a gaseous stream or atmosphere of claim 1, wherein the chamber brings the gaseous stream or atmosphere into contact with the hydrogel particles to absorb at least some of the acidic gas into the absorbed amine-functionalised ionic liquid contained within the hydrogel particles.

31. The acidic gas removal apparatus of claim 30, wherein the chamber comprises an inlet through which gaseous stream or atmosphere can flow to the hydrogel particles and an outlet through which an effluent gaseous stream or atmosphere can flow out from the hydrogel particles.

32. (canceled)
